(19) United States
(12) Patent Application Publication
(10) Pub. No.: US 2025/0259137 A1
(43) Pub. Date: Aug. 14, 2025

(54) LOGISTICS NETWORK PLANNING SYSTEM AND LOGISTICS NETWORK PLANNING METHOD

(71) Applicant: Hitachi, Ltd., Tokyo (JP)

(72) Inventors: Kenji KOIZUMI, Tokyo (JP); Kazuya UYAMA, Tokyo (JP); Akihisa GOTO, Tokyo (JP); Satoshi NAGAHARA, Tokyo (JP)

(21) Appl. No.: 18/965,130

(22) Filed: Dec. 2, 2024

(30) Foreign Application Priority Data
Feb. 14, 2024 (JP) 2024-020539

(51) Int. Cl. G06Q 10/0835; G06Q 10/047

(52) U.S. Cl. CPC G06Q 10/08355; G06Q 10/047

(57) ABSTRACT

A logistics network planning system receives, as an input, existing logistics network data that is data relating to an existing logistics network constituted with a plurality of package routes including two or more warehouses from a first departure warehouse to a last arrival warehouse of a package as components. The system analyzes the existing logistics network data to specify a logistics network feature that is a feature of the existing logistics network. The system constructs an optimization problem that minimizes a target based on the logistics network feature and derives an optimum package route by solving the optimization problem. The system outputs logistics network plan data that is data relating to a planned logistics network including the derived package route.

### CROSS-REFERENCE TO PRIOR APPLICATION

This application relates to and claims the benefit of priority from Japanese Patent Application number 2024-020539, filed on Feb. 14, 2024 the entire disclosure of which is incorporated herein by reference.

### BACKGROUND

The present invention generally relates to logistics network planning.

Regarding transportation planning, for example, a technique disclosed in Japanese Patent Laid-Open No. 2022-48586 is known.

### SUMMARY

With the growth of an EC market, a handling amount of small packages including package delivery services has increased year by year. In contrast to the past, such small packages are desired to be transported and delivered to various destinations. Here, in a current logistics network, a vehicle, a ferry, a railroad, and the like, are employed as transportation means (may be referred to as a transporter) from each warehouse (base of the logistics network) to another warehouse, and they are typically regularly scheduled services (means for transportation and delivery in a time window determined in advance between the warehouses). However, the time window for transportation and destinations are limited in the regularly scheduled services, and thus, it is difficult to directly transport and deliver individual packages to destinations.

In actual operation, packages occurring in a rural area to be transported and delivered to individual destinations are consolidated once to a base warehouse in the rural area and further sorted, transported and delivered in accordance with the destinations. However, because of characteristics of this operation, the base warehouse undertakes all the load, and/or even if there is a regularly scheduled service capable of performing transportation and delivery between warehouses in rural areas, packages are consolidated once to the base warehouse, and thus, there is a possibility that a loading ratio of the regularly scheduled service that directly connects the rural areas decreases.

In this manner, in transportation among warehouses in the logistics network including so-called transfer center (TC)-type warehouses, a problem such as bias of load among the warehouses and/or decrease in a loading ratio of transportation means can occur. As a method for solving such a problem, while it is considered to change sorting performance and roles of the warehouses or reduce the number of transportation means, increase in change of substances such as warehouses and transportation means also increases load.

A logistics network planning system inputs existing logistics network data that is data relating to an existing logistics network constituting a plurality of package routes including two or more warehouses from a first departure warehouse to a last arrival warehouse of a package as components. The system analyzes the existing logistics network data to specify a logistics network feature that is a feature of the existing logistics network. The system constructs an optimization problem that minimizes a target based on one or a plurality of indexes, based on the logistics network feature and derives an optimum package route by solving the optimization problem. The system outputs logistics network plan data that is data representing a planned logistics network including the derived package route.

According to the present invention, it is possible to create an optimum plan of a logistics network with small change of substances such as warehouses and transporters (transportation means). Problems, configurations and effects other than those described above will become clear by the following detailed description of the preferred embodiment.

### BRIEF DESCRIPTION OF THE DRAWINGS

FIG. 1 is a configuration diagram of an overall system including a logistics network planning system according to a first embodiment;

FIG. 2 is a configuration diagram of package data;

FIG. 3 is a configuration diagram of vehicle data;

FIG. 4 is a configuration diagram of warehouse data;

FIG. 5 is a configuration diagram of graph data;

FIG. 6 is a flowchart of processing to be executed by a logistics network planning system 100;

FIG. 7 is a flowchart of processing 602;

FIG. 8 is a schematic view of construction of clustering data in processing 704;

FIG. 9A is a schematic view of a first cluster;

FIG. 9B is a schematic view of a second cluster;

FIG. 10 is a schematic view illustrating an example of a logistics network according to the first embodiment;

FIG. 11 is a flowchart of processing 603;

FIG. 12 is a flowchart of processing 604;

FIG. 13 is a flowchart of processing 1204;

FIG. 14 is a flowchart of processing 1206;

FIG. 15 is a schematic view illustrating an example of a logistics network screen;

FIG. 16 is a schematic view illustrating an example of generation of path candidates;

FIG. 17 is a schematic view illustrating an example of a relationship between divergence from a warehouse role and cost;

FIG. 18 is a schematic view illustrating an example of reduction of maximum warehouse load; and

FIG. 19 is a schematic view illustrating an example of limitation of path candidates.

### DETAILED DESCRIPTION

In the following description, an “interface apparatus” may be one or more interface devices. The one or more interface devices may be at least one of the following.
One or more input/output (I/O) interface devices. The input/output (I/O) interface device is an interface device for at least one of an I/O device or a computer for remote display. The I/O interface device for the computer for display may be a communication interface device. At least one I/O device may be any of a user interface device, for example, either of an input device like a keyboard and a pointing device or an output device like a display device.
One or more communication interface devices. The one or more communication interface devices may be one or more communication interface devices of the same type (for example, may be one or more network interface cards (NICs)) or may be two or more communication interface devices of different types (for example, an NIC and a host bus adapter (HBA)).

Further, in the following description, a “memory” is one or more memory devices that are one example of one or more storage devices, and typically, may be a main storage device. At least one memory device in the memory may be a volatile memory device or may be a non-volatile memory device.

Further, in the following description, a “persistent storage apparatus” may be one or more persistent storage devices that are one example of one or more storage devices. The persistent storage device may be typically a non-volatile storage device (for example, an auxiliary storage device) and may be specifically, for example, a hard disk drive (HDD), a solid state drive (SSD), a non-volatile memory express (NVME) drive or a storage class memory (SCM).

Further, in the following description, the “storage apparatus” may be the “memory” and/or the “persistent storage apparatus”.

Further, in the following description, a “processor” may be one or more processor devices. At least one processor device may be typically a microprocessor device like a central processing unit (CPU) but may be other types of processor devices like a graphics processing unit (GPU). At least one processor device may be a single core or may be a multicore. At least one processor device may be a processor core. At least one processor device may be a processor device in a broad sense such as a circuit that performs part or all of processing by hardware description language and is an aggregate of gate arrays (for example, a field-programmable gate array (FPGA), a complex programmable logic device (CPLD) or an application specific integrated circuit (ASIC)).

Further, in the following description, while information with which an output can be obtained in reaction to an input will be described using expression of “table xxx”, the information may be data having any structure (for example, may be structured data or unstructured data) or may be a neural network that generates an output in reaction to an input, or a learning model typified by a genetic algorithm or random forest. Thus, the “table xxx” can be said as “data xxx”. Further, in the following description, a configuration of each table is one example, and one table may be divided into two or more tables, or all or part of the two or more tables may be one table.

Further, in the following description, while a function will be described using expression of “yyy unit”, the function may be implemented by one or more computer programs being executed by a processor, may be implemented by one or more hardware circuits (for example, an FPGA or an ASIC) or may be implemented by a combination thereof. In a case where the function is implemented by the program being executed by the processor, determined processing is performed using a storage apparatus and/or an interface apparatus, and the like, as appropriate, and thus, the function may be at least part of the processor. Processing described using a function as a subject may be processing to be performed by a processor or an apparatus including the processor. The program may be installed from a program source. The program source may be, for example, a storage medium (for example, a non-transitory storage medium) readable by a program distribution computer or a computer. Description of each function is one example, and a plurality of functions may be integrated into one function, or one function may be divided into a plurality of functions.

Further, as information (identification information, an identifier) for identifying an element, arbitrary information (for example, at least one of an “ID”, “name” or “number”) may be employed.

Further, in the following description, in a case where description is provided without distinguishing elements of the same type, a common reference numeral in a reference numeral is used, and in a case where description is provided while distinguishing elements of the same type, the reference numerals will be used.

Further, in the following description, unit of “time” may be rougher unit or finer unit than year, month, hour, and minute.

An embodiment of a logistics network planning system according to the present invention will be described below with reference to the drawings.

### First Embodiment

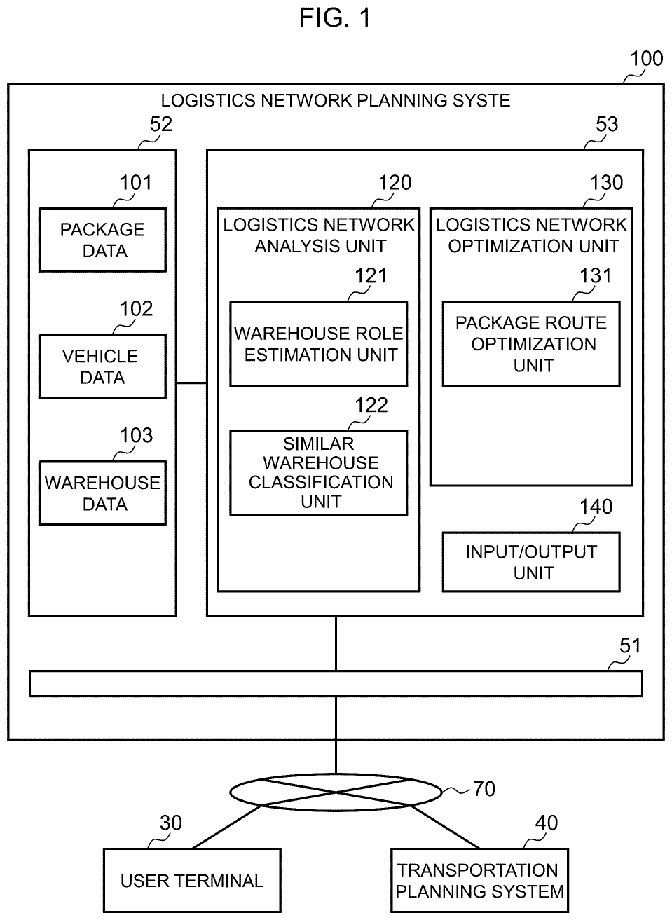

FIG. 1 is a configuration diagram of an overall system including a logistics network planning system 100 according to a first embodiment.

The logistics network planning system 100 creates a logistics network plan and outputs logistics network plan data that is data representing the created logistics network plan. The logistics network plan created in the present embodiment is a plan for balancing load for each warehouse in an existing logistics network. While in the present embodiment, the logistics network planning system 100 is a physical computer system (one or a plurality of computers), the logistics network planning system 100 may be a logical computer system based on a physical computer system (for example, a system as a cloud computer service based on a cloud infrastructure) in place of the physical computer system.

The logistics network planning system 100 includes an interface apparatus 51, a storage apparatus 52 and a processor 53 connected thereto.

The interface apparatus 51 communicates with an external system, for example, at least one of a user terminal 30 or a transportation planning system 40 through a communication network 70 (for example, the Internet or a wide area network (WAN)).

The user terminal 30, which is an information processing terminal (for example, a personal computer or a smartphone), is used by a user. The logistics network planning system 100 may be a server system, and the user terminal 30 may be a client system. The user terminal 30 receives the logistics network plan data from the logistics network planning system 100 and displays information on the logistics network plan. One example of the user is a user. The user is a person who creates a transportation plan based on the logistics network plan. The transportation plan is a plan representing how transportation is performed by a plurality of vehicles in a logistics network represented in the logistics network plan and includes, for example, arrival time and/or departure time at each of two or more warehouses among a plurality of warehouses in the logistics network represented in the logistics network plan for each of the plurality of vehicles. In place of or in addition to the user terminal 30, an input device and an output device as a user interface device may be connected to the interface apparatus 51.

The transportation planning system 40 is a physical or logical computer system. The transportation planning system 40 receives the logistics network plan data from the logistics network planning system 100, creates a transportation plan based on the logistics network plan data and outputs transportation plan data representing the created transportation plan.

Note that data of at least one of the logistics network plan data output from the logistics network planning system 100 or the transportation plan data output from the transportation planning system 40 or the user terminal 30 may be transmitted to at least one of a warehouse terminal, a vehicle or a support system. The warehouse terminal is an information processing terminal provided in the warehouse. The vehicle is one example of transportation means and arrives at and/or departs the warehouse. The support system is one example of a physical or logical computer system, performs information processing using at least part of the logistics network plan data and the transportation plan data and transmits information or an instruction to outside such as the warehouse terminal, the vehicle, or the like. For example, a control apparatus provided in the vehicle may receive data or an instruction from the logistics network planning system 100 or the support system and control operation based on the received data or instruction or display the received data or instruction on an in-vehicle display.

The storage apparatus 52 stores data and a program. The data includes package data 101, vehicle data 102 and warehouse data 103. At least part of these pieces of data 101 to 103 may be stored in advance or may be received as an input from the user terminal 30.

By the processor 53 executing the program, a logistics network analysis unit 120, a logistics network optimization unit 130 and an input/output unit 140 are implemented. The logistics network analysis unit 120 analyzes a logistics network (for example, a feature of the logistics network). The logistics network optimization unit 130 derives a package route based on the analysis result.

The logistics network analysis unit 120 includes a warehouse role estimation unit 121 and a similar warehouse classification unit 122. The logistics network optimization unit 130 includes a package route optimization unit 131. The input/output unit 140 performs selection of data to be used by a user in calculation, setting of a calculation condition, display of a calculation result of the present system 100, and the like. Further, “transportation” may be implemented as “transportation and delivery” in a broad sense. In a case where it is necessary to distinguish between “transportation” and “delivery”, for example, package movement between warehouses may be “transportation” in a narrow sense, and package movement from a warehouse to a delivery destination (for example, destination address of the package) may be “delivery”.

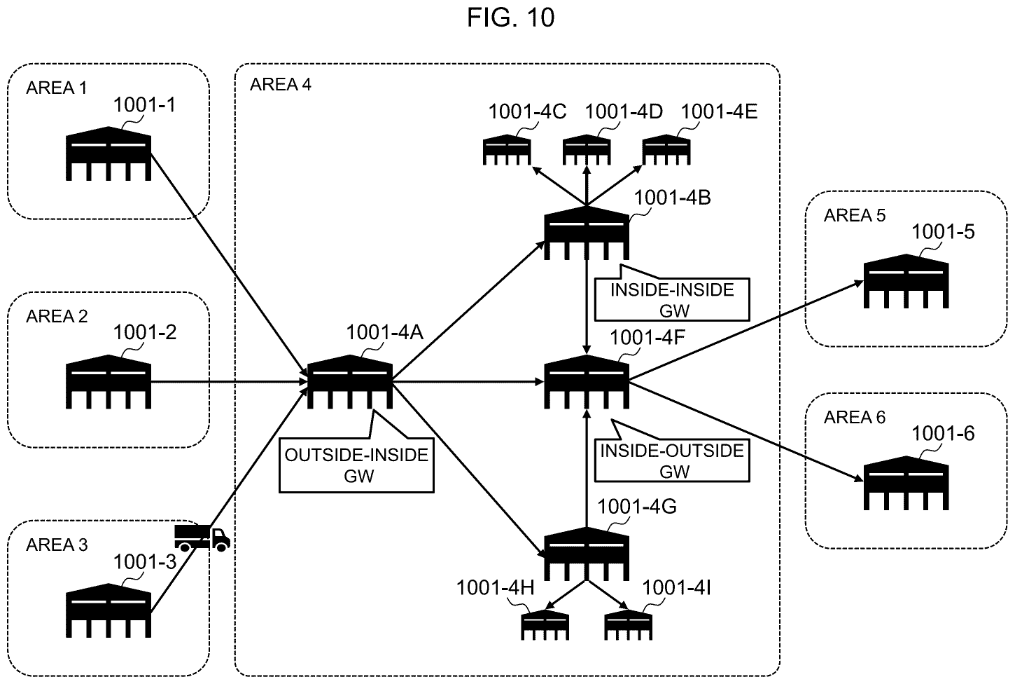

FIG. 10 is a schematic view illustrating an example of the logistics network according to the present embodiment.

In FIG. 10, one or more warehouses 1001 are arranged in areas 1 to 6 (one example of a plurality of areas). Presence of transportation means between the warehouse 1001 and the warehouse 1001 is expressed by connecting the warehouses 1001 with a line. In other words, the logistics network can be expressed with a graph such as a directed graph (DG). In the DG, a vertex corresponds to the warehouse 1001, and an edge connecting the vertexes defines which warehouse 1001 is a movement source and which warehouse 1001 is a movement destination between the warehouses 1001. Thus, a direction of the edge is a moving direction of the vehicle. In the logistics network, the transportation means moves between the warehouses and unloads and/or loads packages at each warehouse in accordance with a structure of the DG representing the logistics network.

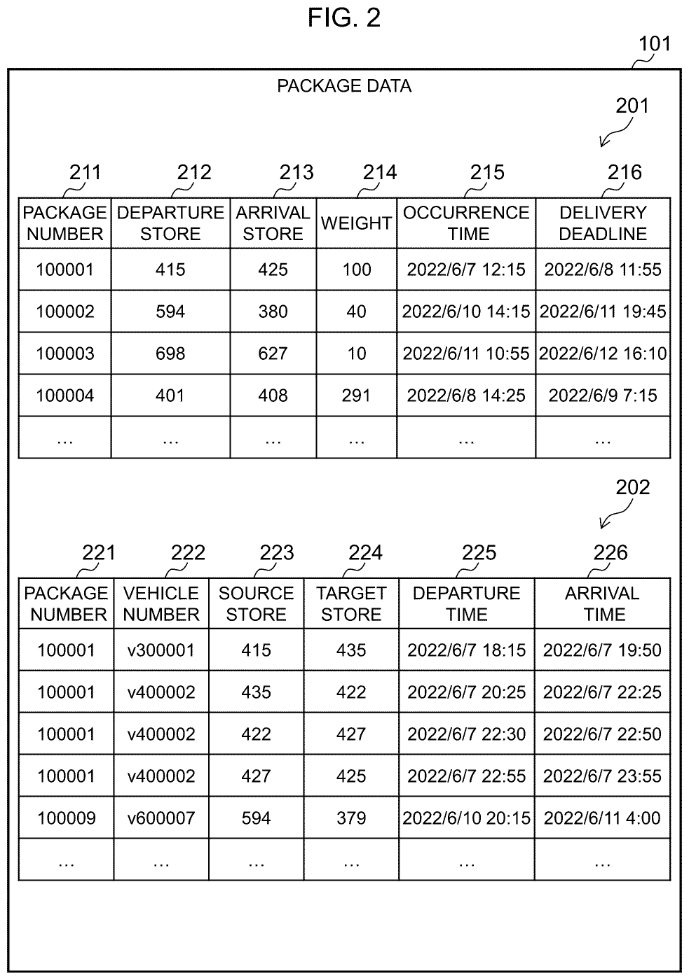

FIG. 2 is a configuration diagram of the package data 101. Note that in the following description, an element with a number or an ID of “X” will be expressed as an element “X”.

The package data 101 indicates various kinds of information on a package transported on the logistics network. Specifically, for example, the package data 101 includes a first package table 201 and a second package table 202.

The first package table 201 includes information on the package itself. For example, the first package table 201 has a row for each package, and the row has information such as a package number 211, a departure store 212, an arrival store 213, a weight 214, occurrence time 215, and a delivery deadline 216. The package number 211 represents a package number for identifying the package. The departure store 212 represents an ID of a departure store (a warehouse as a first departure point). The arrival store 213 represents an ID of an arrival store (a last arrival point). The weight 214 represents a weight of the package. The occurrence time 215 represents occurrence time of the package. The delivery deadline 216 represents a delivery deadline of the package.

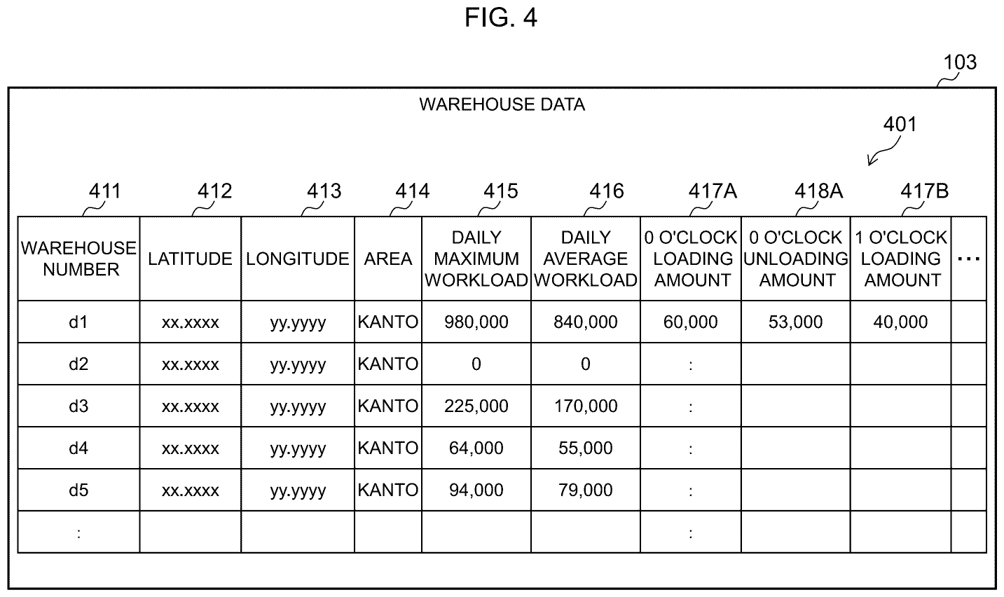

The second package table 202 has information on a package route that is a route taken by the package. The second package table 202 has a row for each package route element. For each package, the “package route element” is an element of the package route, and specifically, a pair of one edge and vertexes on both ends of the edge, in other words, a pair of a source store (a warehouse of a movement source) and a target store (a warehouse of a movement destination). The row has information such as a package number 221, a vehicle number 222, a source store 223, a target store 224, departure time 225 and arrival time 226. The package number 221 represents a package number. The vehicle number 222 represents a number of a vehicle that has transported the package. The source store 223 represents a number of the warehouse of the movement source that the vehicle has passed through. The target store 224 represents a number of the warehouse of the movement destination that the vehicle has passed through. The departure time 225 represents time at which the vehicle has departed the warehouse of the movement source. The arrival time 226 represents time at which the vehicle has arrived at the warehouse of the movement destination. Note that the warehouse numbers as the source store 223 and the target store 224 correspond to the warehouse numbers as warehouse numbers 411 in FIG. 4 which will be described later. For example, the first row of the second package table 202 means that a package “100001” has been transported by a vehicle “v300001”, and the vehicle has departed a movement source warehouse “415” at time “2022 Jun. 7 18:15” and has arrived at a movement destination warehouse “435” at time “2022 Jun. 7 19:50”. This makes it possible to track a location (in a vehicle or in a warehouse) at arbitrary time for each package. Specifically, for example, further, according to the first row of the first package table and the first to the fourth rows of the second package table 202, the package “100001” can be tracked as follows.
A package route of the package “100001” was the warehouse (departure store) “415”→the warehouse “435” →the warehouse “422”→the warehouse “427”→the warehouse (arrival store) “425”.
For each warehouse on the package route, the departure time and the arrival time were as indicated in the first to the fourth rows of the second package table 202.
The package has moved by the vehicle “v300001” from the warehouse (departure store) “415”→the warehouse “435”.
The package has been unloaded from the vehicle “v300001” at the warehouse “425” and has loaded on a vehicle “v400002”.
Thereafter, the package has moved from the warehouse “435” to the warehouse (arrival store) “425” by the vehicle “v400002”.

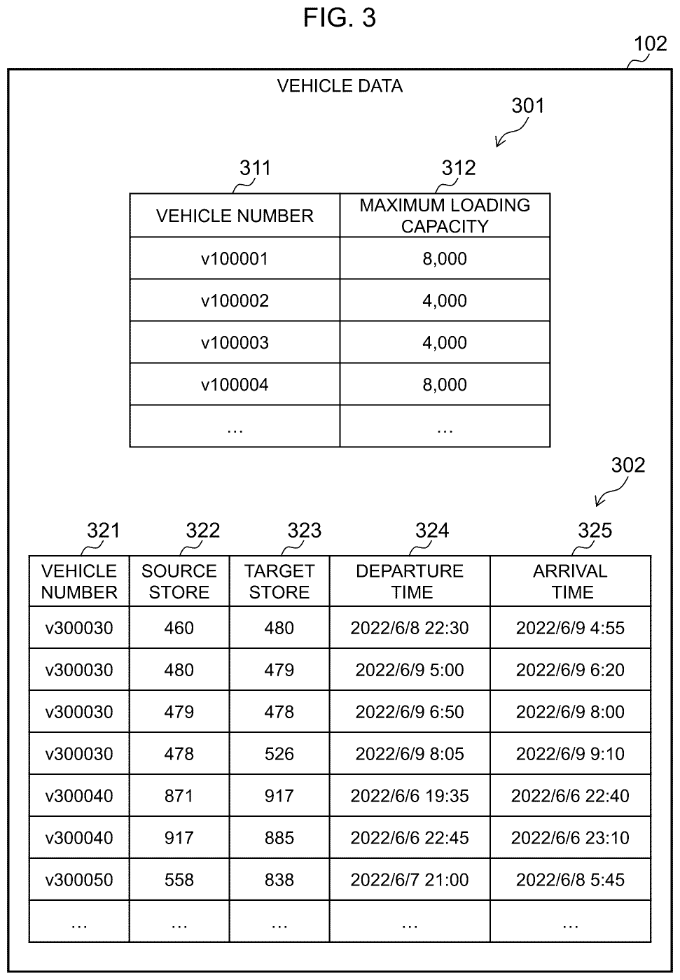

FIG. 3 is a configuration diagram of the vehicle data 102.

The vehicle data 102 indicates various kinds of information on a vehicle that moves in the logistics network. Specifically, for example, the vehicle data 102 includes a first vehicle table 301 and a second vehicle table 302. In the present embodiment, while the transportation means is a vehicle for the sake of convenience, other transportation means such as a ferry and a railroad may be employed as the transportation means in the present invention.

The first vehicle table 301 has information on specifications of the vehicle. The first vehicle table 301 has a row for each vehicle. The row has information such as a vehicle number 311 and a maximum loading capacity 312. The vehicle number 311 represents a vehicle number for identifying the vehicle. The maximum loading capacity 312 represents a maximum loading capacity that is an upper limit of an amount of packages that can be loaded on the vehicle.

The second vehicle table 302 has information on warehouses at which the vehicle departs and arrives at and time of departure and arrival. Hereinafter, a “vehicle diagram” indicates a diagram specified from the second vehicle table 302 (or a table in the same format). The second vehicle table 302 has a row for each vehicle route element. The “vehicle route” is a route taken by the vehicle. The “vehicle route element” is an element of the vehicle route, and specifically, a pair of one edge and vertexes of both ends of the edge, in other words, a pair of a source store (a warehouse of a movement source) and a target store (a warehouse of a movement destination). The row has information such as a vehicle number 321, a source store 322, a target store 323, departure time 324 and arrival time 325. The vehicle number 321 represents a vehicle number. The source store 322 represents a number of the source store (the warehouse of the movement source) that the vehicle has passed through. The target store 323 represents a number of the target store (the warehouse of the movement destination) that the vehicle has passed through. The departure time 324 represents time at which the vehicle has departed the source store. The arrival time 325 represents time at which the vehicle has arrived at the target store. The second vehicle table 302 can be interpreted in a similar manner to the second package table 202, and by reading the warehouses that the vehicle has moved and the departure and arrival time from each row, it is possible to track a location of the vehicle at arbitrary time.

FIG. 4 is a configuration diagram of the warehouse data 103.

The warehouse data 103 includes a warehouse table 401. The warehouse table 401 has a row for each warehouse. The row has information such as a warehouse number 411, latitude 412, longitude 413, an area 414, daily maximum workload 415, daily average workload 416, and a pair of an x o'clock loading amount 417x and an x o'clock unloading amount 418a. “x” is an integral from 0 to 23. α is an alphabetic character such as A, B, . . .

The warehouse number 411 represents a warehouse number for identifying the warehouse. The latitude 412 and the longitude 413 represent latitude and longitude as a coordinate of the warehouse in a map. The area 414 represents name of an area to which the warehouse belongs. The daily maximum workload 415 represents daily maximum workload that is workload of a day in which the workload becomes maximum during a predetermined period. The daily average workload 416 represents daily average workload that is average workload for each day during a predetermined period. The x o'clock loading amount 417a represents a loading amount at x o'clock (for example, an average value of loading amounts at x o'clock during a predetermined period). The x o'clock unloading amount 418a represents an unloading amount at x o'clock (for example, an average value of unloading amounts at x o'clock during a predetermined period). Workload at x o'clock may be, for example, a sum of the unloading amount 418a at x o'clock and the loading amount 417a at x o'clock. The “unloading amount” is an amount of unloaded packages. The “loading amount” is an amount of loaded packages. The “workload” may be a value based on at least one of the unloading amount or the loading amount, for example, a sum of the unloading amount and the loading amount as described above.

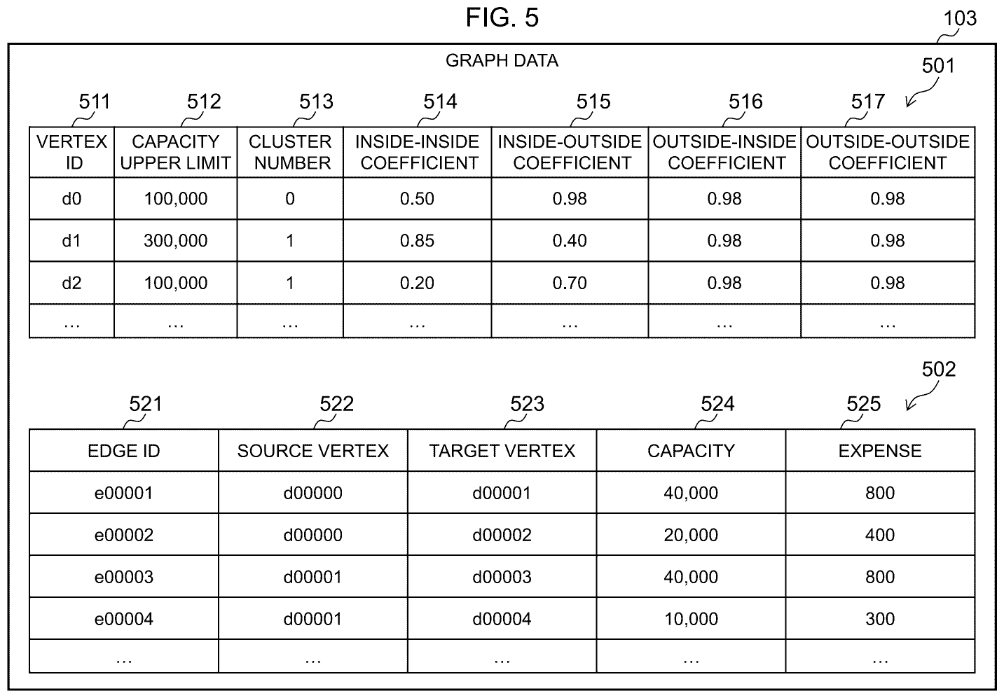

FIG. 5 is a configuration diagram of graph data 104.

The graph data 104 is data that is to be used when the logistics network optimization unit 130 derives the package route and represents the logistics network with a graph network and holds information on a vertex and an edge. The graph data 104 includes a first graph table 501 and a second graph table 502.

The first graph table 501 has information on a vertex. The first graph table 501 has a row for each vertex. The row has information such as a vertex ID 511, a capacity upper limit 512, a cluster number 513, an inside-inside coefficient 514, an inside-outside coefficient 515, an outside-inside coefficient 516, and an outside-outside coefficient 517.

The second graph table 502 has information on an edge. The second graph table 502 has a row for each edge. The row has information such as an edge ID 521, a source vertex 522, a target vertex 523, a capacity 524 and an expense 525. The “source vertex” may be referred to as a parent vertex as one end of the edge. The “target vertex” may be referred to as a child vertex as the other end of the edge.

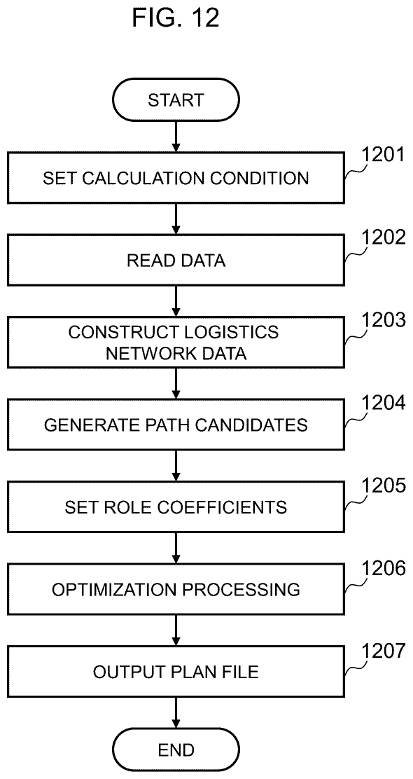

Details of the graph data 104 will be described in description of processing 1203 in FIG. 12.

Hereinafter, concerning operation of the logistics network planning system 100, a process of deriving the package route (package route for balancing load of warehouses) in the logistics network will be described using the data described in FIG. 2 to FIG. 5 described above.

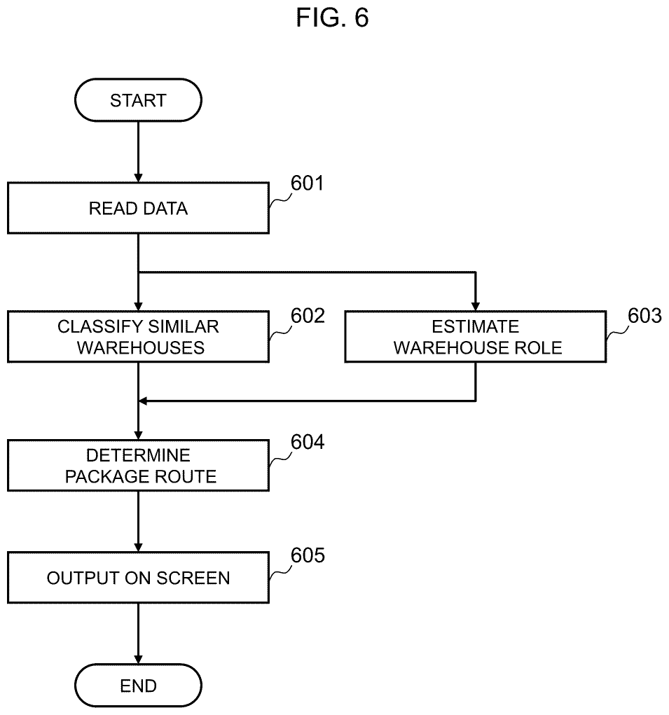

FIG. 6 is a flowchart indicating processing to be performed by the logistics network planning system 100.

The input/output unit 140 executes processing 601. Specifically, the input/output unit 140 reads the package data 101, the vehicle data 102 and the warehouse data 103 necessary for calculation, for example, from a persistent storage apparatus to a memory.

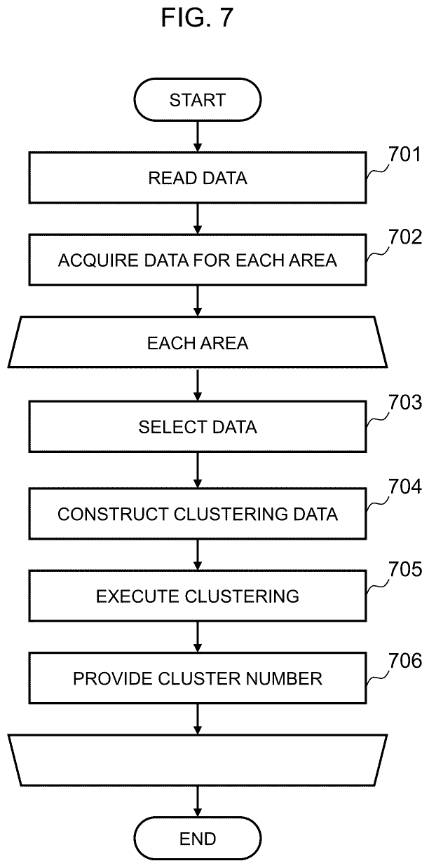

The logistics network analysis unit 120 (warehouse role estimation unit 121) executes processing 602 using the warehouse data 103. Specifically, the logistics network analysis unit 120 classifies warehouses with similar trends of the workload by clustering using workload of existing warehouses for each hour as a main feature. Details of the processing will be described with reference to FIG. 7.

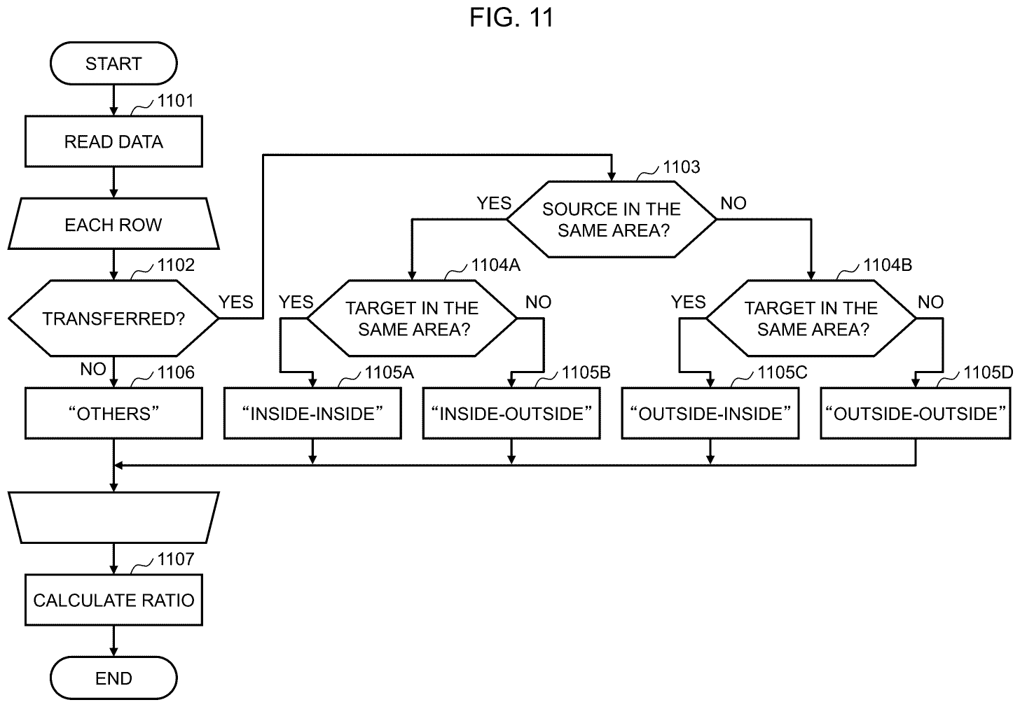

The logistics network analysis unit 120 (similar warehouse classification unit 122) executes processing 603 using the package data 101 and the warehouse data 103. Specifically, the logistics network analysis unit 120 estimates roles when the respective warehouses transport packages inside and outside the area. Details of the processing will be described with reference to FIG. 11. Note that one or both of the processing 602 and the processing 603 may be executed.

The logistics network optimization unit 130 (package route optimization unit 131) executes processing 604 using the package data 101, the vehicle data 102 and the warehouse data 103. Specifically, the package route optimization unit 131 derives a package route that balances amounts of load for each warehouse. Details of the processing will be described with reference to FIG. 12.

Finally, the input/output unit 140 executes processing 605. Specifically, the input/output unit 140 displays the logistics network changed based on the derived package route, the similar warehouse classification result obtained by calculation, the warehouse role estimation result, and the like, on a screen.

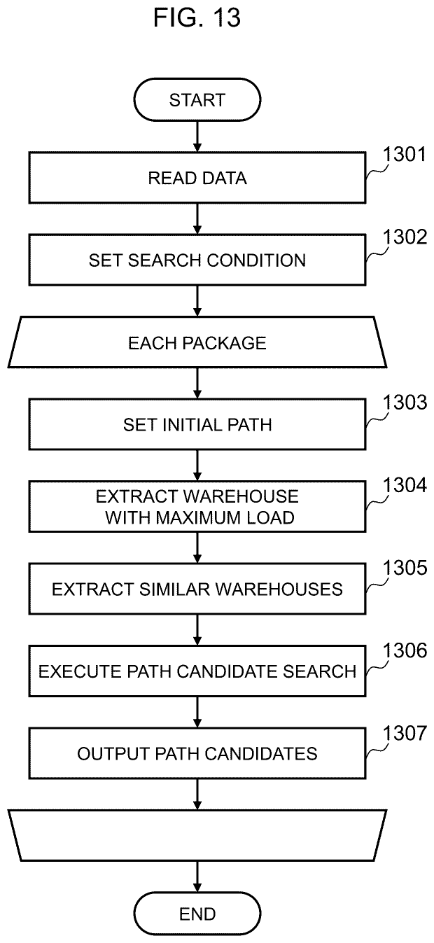

First, details of the processing 602 will be described. In the processing 602, the logistics network analysis unit 120 performs clustering using workload (a sum of the unloading amount and the loading amount) at each time for a plurality of warehouses and peak time of the workload in one day and peak workload as feature amounts and classifies warehouses with similar trends of the workload. The processing 602 is performed in accordance with the flowchart indicated in FIG. 7. Note that the processing 602 does not have to be executed. In a case where the processing 602 is not executed, processing 1304 and processing 1305 do not have to be executed in a flowchart in FIG. 13 which will be described later.

The logistics network analysis unit 120 copies the warehouse data 103 read through the processing 601 on the memory to set as temporary data for calculation in processing 701. Then, the logistics network analysis unit 120 divides the warehouse data 103 for each area in processing 702. Specifically, a set of rows with the same value of the area 414 in the warehouse table 401 can be obtained. For example, in a case where the warehouse table 401 has “Kanto” and “Kinki” as the area 414, the warehouse table 401 is divided into an area warehouse table 401_1 only including rows with the area 414 of “Kanto” and an area warehouse table 401_2 only including rows with the area 414 of “Kinki” (illustration in the figure is omitted). Further, for the area warehouse table divided for each area (that is, for each area warehouse table), the logistics network analysis unit 120 executes processing 703 to processing 705.

The logistics network analysis unit 120 selects the divided area warehouse table for which calculation is to be performed (for example, the area warehouse table 401_1 described above) in processing 703. Then, the logistics network analysis unit 120 constructs clustering data of each warehouse in processing 704. Note that to avoid complication, hereinafter, the area warehouse table will be simply described as warehouse data 103 assuming that there is only a single area.

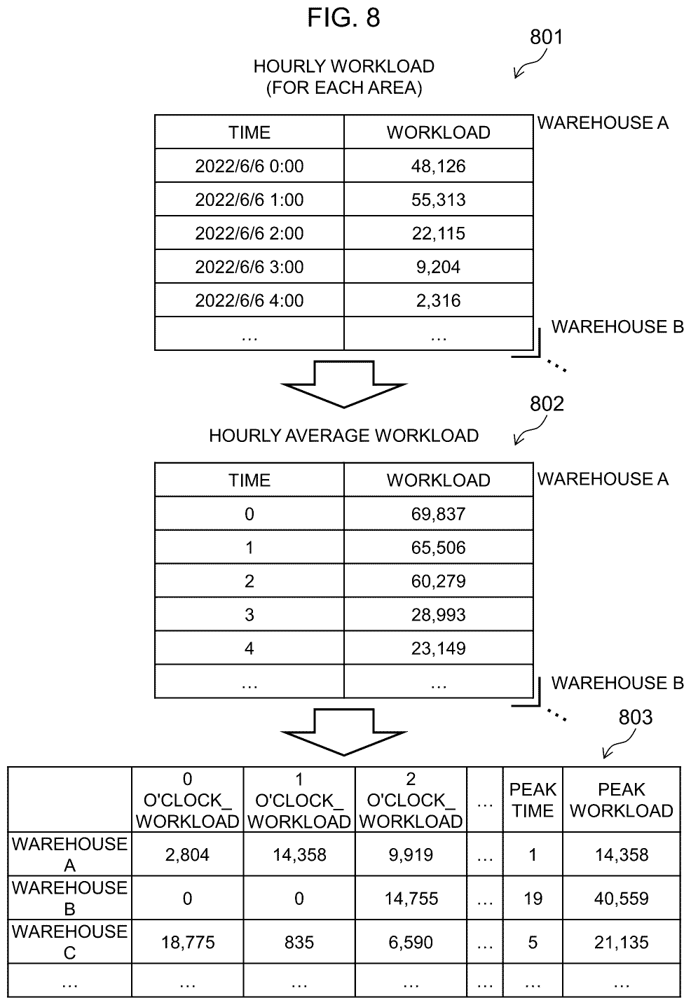

FIG. 8 is a schematic view of construction of the clustering data.

The logistics network analysis unit 120 creates a first table 801 by converting the workload at each time held in the warehouse data 103 into a time-series format for each warehouse. While in the present embodiment, the workload is a sum of the unloading amount and the loading amount, the workload may be one of the unloading amount or the loading amount. The logistics network analysis unit 120 creates a second table 802 by converting the first table 801 into an average value per hour from 0 o'clock to 23 o'clock during a predetermined period (for example, one week) for each warehouse. For example, the first row of the second table 802 represents an average value of the workload at 0:00 during the predetermined period.

In addition, the logistics network analysis unit 120 extracts time (peak time) at which the workload is the highest and the workload (peak workload) at the peak time from the second table 802 as a feature amount for clustering the unloading amount and the loading amount. From the data extracted in this manner, the logistics network analysis unit 120 creates a third table 803 including a sum of the workload at each time, the peak time and a value of the peak workload for each warehouse as elements.

The logistics network analysis unit 120 classifies warehouses by constructing a two-dimensional matrix including values of the respective rows in the third table 803 as elements and executing clustering in processing 705 indicated in FIG. 7. As the clustering method, for example, an existing method such as a K-means method may be applied. Further, the number of clusters when the K-means method is applied may be stored in advance in a storage area of the logistics network planning system 100 and may be read from the storage area or may be provided from the user terminal 30.

Finally, the logistics network analysis unit 120 allocates cluster numbers obtained as the clustering result to the respective warehouses in processing 706. Specifically, for example, the logistics network analysis unit 120 adds a column of a “cluster number” to the warehouse data 103 and stores corresponding numbers. The numbers in this event are unique numbers so as not to overlap with clustering results in other area warehouse tables.

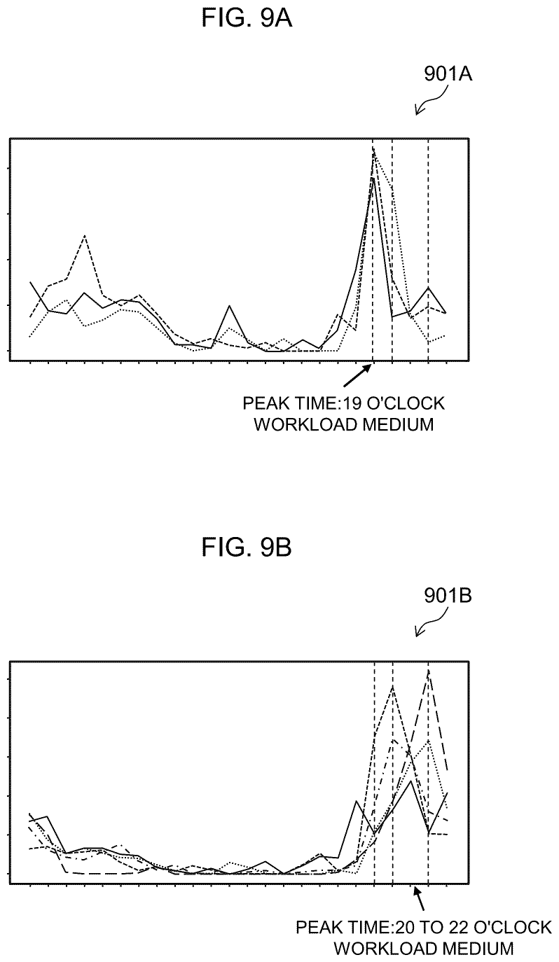

FIG. 9A is a schematic view of a first cluster obtained in the processing 602. FIG. 9B is a schematic view of a second cluster obtained in the processing 602.

The cluster is a cluster of warehouses having the same cluster number. A cluster trend graph 901 indicates time on a horizontal axis, indicates workload on a vertical axis, and indicates a warehouse with a broken line.

According to a trend graph 901A of the first cluster and a trend graph 901B of the second cluster, a peak of the workload occurs from 19 to 20 o'clock in the warehouses constituting the first cluster, and a peak occurs from 20 to 22 o'clock in the warehouses constituting the second cluster. By this means, the user can obtain information on a combination of warehouses to which load is to be balanced by interpreting the trend graphs. For example, the user or the package route optimization unit 131 can recognize that the second cluster has room of the workload from 19 o'clock to 20 o'clock, and thus, part of the workload from 19 o'clock to 20 o'clock in the first cluster can be shifted to the second cluster. For example, the package route optimization unit 131 may omit a combination of warehouses for which an effect of load balance cannot be obtained (for example, a combination of warehouses having peaks of the workload at the same time) in advance. Further, the input/output unit 140 may display these trend graphs 901A and 901B on the user terminal 30.

As indicated in FIG. 6, the logistics network analysis unit 120 estimates roles of the respective warehouses in the existing logistics network in the processing 603 in parallel to the processing 602 (subsequent to the processing 602). Note that the processing 603 does not have to be executed. In this case, processing 1205 does not have to be executed in a flowchart of FIG. 12 which will be described later.

As described above, FIG. 10 is a schematic view illustrating an example of the logistics network.

This drawing illustrates warehouse roles. Specifically, the warehouses constituting the logistics network include warehouses having a role of appropriately sorting destinations of packages by inside and outside of the area (in the present embodiment, referred to as gateways (GWs)) and warehouses that become terminals of the logistics network. In other words, warehouses corresponding to vertexes having intermediate vertexes (a source vertex and a target vertex) are GWs, and warehouses corresponding to one of a root vertex (a vertex not having the source vertex) and a leaf vertex (a vertex not having the target vertex) are warehouses at terminals.

For example, description will be provided using an example of an area 4. A warehouse 1001-4A is a warehouse that has a role of sorting packages transported from an area other than the area 4 to inside of the area 4 (referred to as an outside-inside GW). Further, there are a warehouse that has a role of sorting packages transported from inside of the area 4 to inside of the area 4 like a warehouse 1001-4B (referred to as an inside-inside GW) and a warehouse that has a role of sorting packages transported from inside of the area 4 to an area outside the area 4 like a warehouse 1001-4F (referred to as an inside-outside GW). Other than these, there may be a warehouse that has a role of sorting packages transported from an area outside the area 4 to another area outside the area 4 (referred to as an outside-outside GW). Further, each warehouse may have a plurality of roles such as a role of the outside-inside GW in specific time windows while having a role of the inside-inside GW in other time windows as well as a single role as the GW.

FIG. 11 is a flowchart of the processing 603.

In the processing 603, the logistics network analysis unit 120 estimates roles of the respective warehouses for which operation (roles) has become ambiguous over years.

Specifically, the logistics network analysis unit 120 copies the package data 101 and the warehouse data 103 read through the processing 601 on the memory to set temporary data for calculation in processing 1101. Then, the logistics network analysis unit 120 performs processing 1102 to 1106 on each row one by one with reference to the second package table 202 relating to the package route among the package data 101. A row number of the row to be referred to is set as i (it is assumed that i is equal to or greater than 0 and is a total number of rows of the package route-1 for reasons of the program). Further, hereinafter, in description of FIG. 11, in a case where the information to be referred to is information in the x-th row, x is added to an end of the information to simplify the description.

The logistics network analysis unit 120 refers to the columns of the package number 221 and the vehicle number 222 in the i-th row and the (i+1)-th row of the second package table 202 in processing 1102. Here, in a case where the package number 221i is the same as the package number 221(i+1), and the vehicle number 222i is different from the vehicle number 222 (i+1), the logistics network analysis unit 120 determines that transfer of the vehicle occurred (processing 1102: Yes).

In a case where the determination result of the processing 1102 is Yes, the logistics network analysis unit 120 further determines whether the target store and the source store are located in the same area for the i-th row in processing 1103. Specifically, for example, the logistics network analysis unit 120 determines whether the area 414 corresponding to the warehouse number 411 that matches the target store 224i is the same as the area 414 corresponding to the warehouse number 411 that matches the source store 223i with reference to the warehouse data 103.

In a case where the target store i and the source store i are located in the same area (processing 1103: Yes), that is, in a case where a package route element corresponding to the i-th row is a branch line, the logistics network analysis unit 120 determines whether the area 414 corresponding to the target store 224i+1 is the same as the area 414 corresponding to the source store 223 (i+1) in processing 1104A.

In a case where the target store i (the source store i+1) and the target store i+1 are located in the same area (processing 1104A: Yes), that is, in a case where a package route element corresponding to the (i+1)-th row is also a branch line, the logistics network analysis unit 120 provides a label “inside-inside” to the i-th row in processing 1105A. This represents that the warehouse corresponding to the target store 224 in the i-th row has a role of the inside-inside GW (see a reference numeral 1001-4B in FIG. 10) that sorts packages that have arrived from inside of the area to a vehicle directed to a warehouse inside the same area. Note that the label may be provided by writing a value as a label to a column “label” added to the second package table 202.

In a case where the target store i (source store i+1) and the target store i+1 are located in different areas (processing 1104A: No), that is, in a case where a package route element corresponding to the (i+1)-th row is a trunk line, the logistics network analysis unit 120 provides a label “inside-outside” to the i-th row in processing 1105B.

In a case where the target store i and the source store i are located in different areas (processing 1103: No), that is, in a case where a package route element corresponding to the i-th row is a trunk line, the logistics network analysis unit 120 determines whether the area 414 corresponding to the target store 224i+1 is the same as the area 414 corresponding to the source store 223 (i+1) in processing 1104B.

In a case where the target store i (source store i+1) and the target store i+1 are located in the same area (processing 1104B: Yes), that is, in a case where the package route element corresponding to the (i+1)-th row is a branch line, the logistics network analysis unit 120 provides a label “outside-inside” to the i-th row in processing 1105C.

In a case where the target store i (source store i+1) and the target store i+1 are located in different areas (processing 1104B: No), that is, in a case where the package route element corresponding to the (i+1)-th row is also a trunk line, the logistics network analysis unit 120 provides a label “outside-outside” to the i-th row in processing 1105D.

In a case where the determination result of the processing 1102 is No, that is, in a case where the package number 221i is different from the package number 221(i+1) (that is, the package corresponding to the i-th row has reached the arrival store) or the vehicle number 222i is the same as the vehicle number 222 (i+1), the target store i does not have a role as the GW, and the logistics network analysis unit 120 provides a label “others” meaning roles other than the GW to the i-th row in processing 1106.

Finally, the logistics network analysis unit 120 calculates a ratio of the number of labels for each warehouse in processing 1107 (figure is omitted). This processing is executed, for example, through the following procedure. First, the logistics network analysis unit 120 adds label columns of “inside-inside”, “inside-outside”, “outside-inside”, “outside-outside” and “others” to the warehouse table 401. Then, for each row of the second package table 202, the logistics network analysis unit 120 increments the number of labels in a label column corresponding to the label provided to the row among added five label columns relating to a warehouse having a warehouse number that matches the target store 224 with reference to the target store 224. Then, the logistics network analysis unit 120 calculates a sum of the number of labels of the five labels for each warehouse. Further, the logistics network analysis unit 120 calculates a “label ratio=the number of labels/a total number of five labels” for each of the five labels and stores the label ratio corresponding to the label column to each of the five label columns in the warehouse table 401. Through the above-described processing, the label ratio (ratio of the number of labels) is calculated for each label for each warehouse.

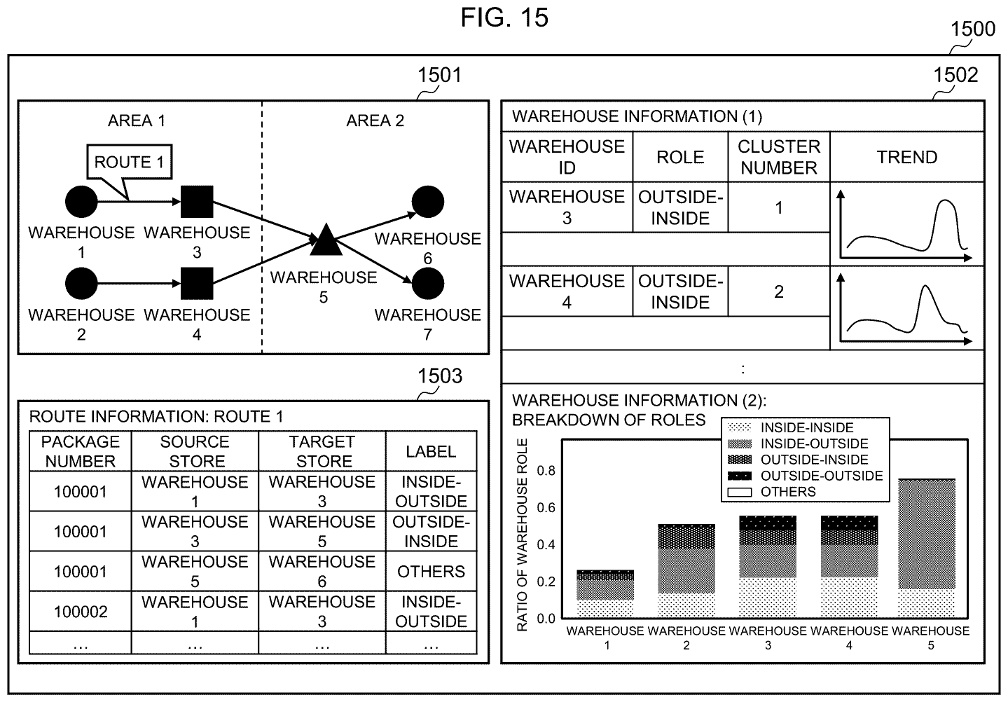

The label ratio obtained by the logistics network analysis unit 120 executing the processing 603 can be confirmed by, for example, a graph of “breakdown of roles” in a second screen element 1502 on a logistics network screen 1500 illustrated in FIG. 15. The present graph is a stacked bar graph indicating the warehouse number on a horizontal axis and indicating the label ratio of the warehouse on a vertical axis. In a case of a warehouse 5, a role as the “inside-inside GW” is 15%, a role as the “inside-outside GW” is 60%, and “others” is 25%.

Description returns to the flowchart in FIG. 6 again.

After the processing 602 and the processing 603 described above, the logistics network optimization unit 130 executes processing 604, that is, derives a package route. Details of the processing 604 will be described using the flowchart indicated in FIG. 12. In the present flowchart, processing of deriving a package route that balances load among the warehouses in the logistics network using an optimization technique is executed.

First, the logistics network optimization unit 130 sets a calculation condition to be used in creation of a plan in processing 1201. As the calculation condition, first, there are “start date and time” and “end date and time” of the logistics network for which a plan is to be created. The “start date and time” and the “end date and time” may be received as an input from a screen when a user of the present system starts the logistics network planning system 100 or may be set by being stored as a file in a storage area of the logistics network planning system 100 in advance and the file being read by the logistics network optimization unit 130. In addition, information on an expense required for moving between the warehouses is also set. The expense may be received as an input from the screen by the user or may be set by being read from the file stored in the storage area in a similar manner. For example, a table representing correspondence between a pair of warehouse numbers of two warehouses and a real value as the expense may be set.

Then, the logistics network optimization unit 130 reads data to be used in creation of a plan in processing 1202. Specifically, the logistics network optimization unit 130 copies the package data 101, the vehicle data 102 and the warehouse data 103 read through the processing 601 on the memory to set as temporary data for calculation.

Further, in processing 1202, the logistics network optimization unit 130 selects a package that has already occurred at a start date and time point or occurs between the start date and time and the end date and time from the package data 101 and sets the package as target package data 101T (a first package table 201T and a second package table 202T). Whether or not the package has occurred at the start date and time point may be whether or not occurrence time 215 of a certain package in the first package table 201 is before the start date and time, and last arrival time 226 of the package described in the second package table 202 (that is, time at which the package has arrived at the arrival store and has become no longer a transportation target in the logistics network) is after the start date and time. Whether or not the package occurs between the start date and time and the end date and time may be whether or not the occurrence time 215 of a certain package in the first package table 201 is after the start date and time and before the end date and time.

Through the similar procedure, in the processing 1202, the logistics network optimization unit 130 selects a vehicle that has already occurred at the start date and time point (the vehicle has already departed the first departure store and has not yet arrived at the last arrival store) or occurs between the start date and time and the end date and time also in the vehicle data 102 and sets the vehicle as target vehicle data 102T (a first vehicle table 301T and a second vehicle table 302T).

Note that the warehouse data 103 is used as is. In other words, for the warehouse data 103, it is not necessary to perform processing to be performed in the processing 1202 relating to the package data 101 and the vehicle data 102.

Then, the logistics network optimization unit 130 constructs data of the logistics network to be used in the subsequent processing in processing 1203. The data of the logistics network is the graph data 104 including the first graph table 501 and the second graph table 502 described in FIG. 5. The graph data 104 is stored in the storage apparatus 52.

In the processing 1203, first, the logistics network optimization unit 130 constructs the first graph table 501 corresponding to a vertex. Specifically, the logistics network optimization unit 130 acquires the warehouse number 411 from the warehouse table 401 of the warehouse data 103 and sets a vertex ID 511 in the first graph table 501 based on the warehouse number 411. The logistics network optimization unit 130 acquires the daily maximum workload 415 from the warehouse table 401 for each warehouse and sets the capacity upper limit 512 representing a capacity upper limit at the vertex ID 511 corresponding to the warehouse based on the daily maximum workload 415. The capacity upper limit 512 may be modified so as to become a great value by multiplying the daily maximum workload 415 by an appropriate coefficient without simply using the daily maximum workload 415. Further, the logistics network optimization unit 130 sets a cluster number of the warehouse calculated in the processing 602 as the cluster number 513 of the first graph table 501. Finally, the logistics network optimization unit 130 sets the inside-inside coefficient 514, the inside-outside coefficient 515, the outside-inside coefficient 516 and the outside-outside coefficient 517 from the label ratio calculated for each label (warehouse role) in the processing 603. Each of the coefficients 514 to 517 is based on the label ratio corresponding to the label coefficient. Specifically, for example, for a vertex corresponding to a certain warehouse, the inside-inside coefficient 514 is obtained by subtracting the label ratio (real number from 0.0 to 1.0) of the label “inside-inside” of the warehouse from 1. More specifically, for example, concerning a warehouse having the vertex ID 511 of “d0” described in FIG. 5, if the label ratio of “inside-inside” is 0.50, the inside-inside coefficient 514 can be calculated as “1 −0.50=0.50”. This similarly applies to other labels. Note that while in the embodiment, a value obtained by subtracting the label ratio from 1 is set for simplification, other calculation schemes may be employed if the label coefficient is set so that the cost becomes lower as the label ratio (or a frequency) becomes higher (in other words, if the label coefficient is set so that the cost becomes higher as the label ratio (or the frequency) becomes lower).

In the processing 1203, the logistics network optimization unit 130 then calculates edges and attributes of the edges that connect respective vertexes constructed in the first graph table 501 to construct the second graph table 502. The logistics network optimization unit 130 determines whether or not to draw the edge depending on whether or not a vehicle that moves between arbitrary two vertexes exists with reference to the second vehicle table 302T of the vehicle data 102T after the selection. In a case where a vehicle exists, the logistics network optimization unit 130 sets the edge ID 521 (for example, sequentially allocates IDs starting from “e00001”) and sets the source vertex 522 and the target vertex 523 representing vertex IDs corresponding to the warehouses (the source store and the target store) between which the vehicle has moved at a source vertex (starting point) and a target vertex (end point) of the edge. Then, the logistics network optimization unit 130 calculates a capacity as the attribute of the edge and sets the calculated capacity 524. For each edge, the logistics network optimization unit 130 extracts one or more vehicles that have moved between the source store and the target store corresponding to the source vertex and the target vertex of the edge from the second vehicle table 302T, and the capacity 524 may be a sum of the maximum loading capacities 312 of the one or more vehicles. Finally, the logistics network optimization unit 130 sets an expense when the vehicle moves on the edge from the calculation condition set in the processing 1201 described above. The “expense” described here is set from, for example, a fuel expense and a personnel cost required for moving between warehouses. While the “expense” is set for convenience, the expense is one example of cost, and the cost may be set based on an arbitrary index such as a moving distance between the warehouses, a moving period and environmental load (for example, a CO2 emission amount) in place of or in addition to the expense.

The logistics network optimization unit 130 then generates path candidates that become one of an input of optimization in processing 1204. Details of the processing 1204 will be described using FIG. 13.

First, the logistics network optimization unit 130 reads data in processing 1301. The data read here is the first graph table 501 and the second graph table 502 constituting the graph data 104 of the logistics network.

The logistics network optimization unit 130 then sets a search condition in generation of path candidates in processing 1303. The search condition may be received as an input from a screen by the user or may be specified from an external file, or the like, stored in advance. Note that the search condition to be set here may be an “a maximum depth of the path candidates” (for example, an integer value) and a “expense upper limit of the path candidates” to be used in processing 1306 which will be described later.

After the search condition is set, the logistics network optimization unit 130 searches for path candidates by executing processing 1303 to 1307 for each package of the package data 101T. For convenience of explanation, a package being selected is set as a package k.

In the search, first, the logistics network optimization unit 130 extracts a route in a past record of the package k in processing 1303. This is executed by extracting all rows having the package number 221 of the package k in the second package table 202T of the package data 101T and extracting the source store 223 at which the vehicle number 222 has changed (that is, the package transferred between the vehicles) and the target store 224 through which the package has passed last. For example, in description using the second package table 202 in FIG. 2, warehouses visited by the package “100001” are “415→435→422→427→425”. Among them, the source store 223 at which the vehicle number 222 has changed and the target store 224 through which the package has passed last are extracted as “415→435→425”. From the visiting order in this event, an initial path p_k_init is set as (415, 435, 425).

Then, the logistics network optimization unit 130 extracts a warehouse with the highest daily workload in the initial path in processing 1304. This processing can be performed by extracting a warehouse with a maximum value of the “daily average workload 416/the daily maximum workload 415” with reference to the warehouse table 401 of the warehouse data 103 for the respective warehouses except the first and the last warehouses in the initial path. The warehouse obtained here is set as a maximum load warehouse d_k_max.

Further, the logistics network optimization unit 130 acquires warehouses similar to the maximum load warehouse d_k_max in processing 1305. This can be obtained by extracting warehouse numbers of warehouses having the same cluster number as a cluster number of the maximum load warehouse d_k_max with reference to the cluster number provided after the logistics network analysis unit 120 executes the similar warehouse classification unit 122. The obtained warehouse numbers are held on the memory as an aggregate having the number of elements of 0 or more.

The logistics network optimization unit 130 lists path candidates from the departure store 212 to the arrival store 213 of the package k in processing 1306 based on the condition obtained through the above processing. Listing of the path candidates can be implemented by using an existing graph search algorithm such as depth-first search and breadth-first search. Further, all paths from the departure store 212 to the arrival store 213 of the package k may be listed. In this event, the logistics network optimization unit 130 excludes path candidates that satisfy one of the following three conditions from final path candidates.

(Condition 1) A depth of the path candidate exceeds the “maximum depth of the path candidates” held by the logistics network optimization unit 130.
(Condition 2) A total expense of edges constituting the path candidate exceeds the “expense upper limit of the path candidates”.
(Condition 3) During search, the path candidate passes through the warehouses similar to the maximum load warehouse d_k_max.

Finally, the logistics network optimization unit 130 holds data representing path candidates (an aggregate of one or more paths) corresponding to the package k on the memory in processing 1307. This data may be, for example, a table having the package number of the package k as a key and the path candidates as values.

Description will be returned to FIG. 12. After the path candidates are generated, the logistics network optimization unit 130 then sets coefficients according to the warehouse roles (label ratios) for the edges constituting each path candidate in processing 1205. When an edge entering a certain warehouse is drawn, the warehouse role in the path changes depending on whether the edge is drawn from the warehouse outside the area or drawn from inside of the area. The present processing 1205 is executed to set the expense in accordance with the warehouse role in the existing logistics network in processing 1206 (optimization processing) which will be described later.

For convenience sake, the logistics network optimization unit 130 selects one path candidate for a certain package k and sets p_k=(d1, d2, d3). In this event, d1, d2 and d3 are respectively warehouse numbers, and edges constituting the path candidate are (d1, d2) and (d2, d3).

The logistics network optimization unit 130 first discriminates a movement type when the package moves on the edge for each of the edges constituting each path candidate. Here, the “movement type” is a branch line (two warehouses corresponding to the source vertex and the target vertex of the edge are located in the same area) or a trunk line (two warehouses corresponding to the source vertex and the target vertex of the edge are located in different areas). Further, the logistics network optimization unit 130 acquires a combination of a movement type of an edge on an entry side, and a movement type of an edge on an exit side for each warehouse described in the path candidate. For example, in the above-described path candidate p_k, if d1 and d2 are located in the same area, and d2 and d3 are located in different areas, the edge (d1, d2) becomes the branch line, and the edge (d2, d3) becomes the trunk line. Here, assuming d2 as a base point, in the path candidate p_k, d2 sorts packages transported from inside of the area to an area outside the area, that is, serves as the inside-outside GW. In this manner, the logistics network optimization unit 130 can set coefficients (γ\hat{ }{path candidate}_{the warehouse number of the starting point, the warehouse number of the end point}) in advance for the respective edges constituting the path by determining roles of the warehouses constituting the path candidate and specifying coefficients in accordance with warehouse roles in the past records from the first graph table 501. In the above-described example, the edge (d1, d2) is an edge that passes through the inside-outside GW on this path candidate p_k, and thus, γ\hat{ }{p_k}_{d1, d2}=0.70 (equal to the inside-outside coefficient of the vertex d2).

Further, as a constant to be used in the later optimization problem, the logistics network optimization unit 130 generates a constant δ\hat{ }{p}_{i, j} as to whether each edge is included in the path candidate. This is a constant that becomes 1 when an edge (i, j) is included in the path candidate p, and becomes 0 when the edge (i, j) is not included in the path candidate p. The edges are confirmed one by one in the processing of determining the role coefficients described above, and thus, calculation can be performed at the same time.

In this manner, the logistics network optimization unit 130 constructs the optimization problem in the processing 1206 after setting the coefficients and the constants of the respective edges constituting the path candidate for all the path candidates and derives an optimum package route by solving the optimization problem.

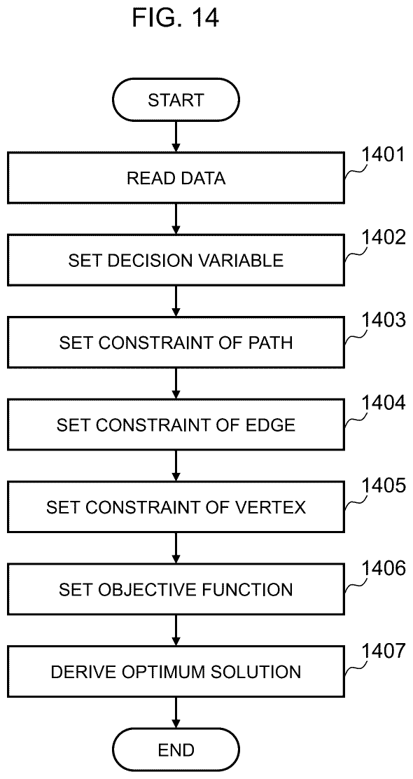

The processing 1206 will be described with reference to FIG. 14.

First, the logistics network optimization unit 130 reads a set of data to be used in the optimization processing in processing 1401. The data to be read is the first graph table 501 and the second graph table 502 of the logistics network data, the data of all the path candidates generated in the processing 1204, and the coefficient γ\hat{ }{p_k}_{dᵢ, dⱼ} and the constant δ\hat{ }{p}_{i, j}for each of the edges constituting the path candidate set in the processing 1205.

To construct the optimization problem, the logistics network optimization unit 130 generates a decision variable in processing 1402. The decision variable includes two types of a decision variable relating to the path candidate and a decision variable relating to reduction of load of the warehouse.

First, the decision variable relating to the path candidate will be described. Concerning the path candidate generated in the processing 1204 described above, an aggregate of path candidates relating to the package k is set as P\hat{ }{k}={p_k| the path candidates for the package k}. Each path candidate is a route that connects from the departure store to the arrival store of the package. To derive a route for the package to reach the arrival store, it is necessary to select at least one path candidate from the aggregate of the path candidates P\hat{ }{k}. Thus, the logistics network optimization unit 130 makes setting as indicated in expression (1) as the decision variable that selects the path candidate.

$$\begin{matrix}[ Math . 1 ] & \\ {z}_{p}^{k} ∈ \{ 0 , 1 \} , p ∈ {P}^{k} , k ∈ K & ( 1 )\end{matrix}$$

When a value of z\hat{ }{k}_{p} is 1, it means that the path candidate p is used to carry the package k. Here, K indicates all packages held by the package data 101T.

Further, to achieve workload balance among the warehouses, the logistics network optimization unit 130 sets expression (2) as the decision variable for reducing an amount of inflow to each warehouse.

$$\begin{matrix}[ Math . 2 ] & \\ L ∈ {R}^{+} & ( 2 )\end{matrix}$$

Here, R\hat{ }{+} is a set of positive real numbers.

Then, the logistics network optimization unit 130 sets constraints from processing 1403 to processing 1405. First, in the processing 1403, the logistics network optimization unit 130 sets a constraint relating to the path.

As described above, in order for the package to reach the arrival store from the departure store, it is necessary to select at least one path candidate. Further, to uniquely determine the solution, only one path candidate must be selected without selecting a plurality of path candidates. Such a constraint is as indicated in, for example, expression (3).

$$\begin{matrix}[ Math . 3 ] & \\ {\sum }_{p ∈ {P}^{k}} {z}_{p}^{k} = 1 , k ∈ K & ( 3 )\end{matrix}$$

Then, the logistics network optimization unit 130 sets a constraint relating to an edge in the processing 1404. The capacity obtained from the past record in the vehicle diagram is set for each edge (i, j). This means an upper limit of the weight of packages that can be transported during a predetermined planned period for the edge (i, j). This is not necessary set for one vehicle and may be set by adding maximum load capacities of a plurality of vehicles. The logistics network optimization unit 130 provides a constraint indicated below in expression (4) so that an amount of planned packages does not exceed this upper limit.

$$\begin{matrix}[ Math . 4 ] & \\ \begin{matrix}{\sum }_{k ∈ K} & {\sum }_{p ∈ {P}^{k}} {w}_{k}\end{matrix} {δ}_{i , j}^{p} {z}_{p}^{k} \leq {Cap}_{i , j}^{3} , ( i , j ) ∈ E & ( 4 )\end{matrix}$$

Here, w_{k} is a weight of the package k, E is an aggregate of all the edges indicated in the second graph table 502, and Cap\hat{ }{e}_{ij} is a capacity of the edge (i, j).

Then, the logistics network optimization unit 130 sets a constraint relating to a vertex in the processing 1405. Specifically, this constraint is a constraint that the amount of packages to be flowed into the warehouse should not exceed the upper limit for the capacity upper limit of each warehouse. This can be implemented by setting a constraint such that a value obtained by adding weights of flowing packages when the edge that flows into the warehouse is selected as the path of the package route becomes equal to or less than the capacity upper limit. Specifically, the logistics network optimization unit 130 adds the constraint in expression (5).

$$\begin{matrix}[ Math . 5 ] & \\ \begin{matrix}{\sum }_{i ∈ D} & {\sum }_{k ∈ K} & {\sum }_{p ∈ {P}^{k}} & {w}_{k} {δ}_{i , j}^{p} {z}_{p}^{k} \leq {Cap}_{j}^{d} , j ∈ D\end{matrix} & ( 5 )\end{matrix}$$

Here, D represents an aggregate of all the warehouses, and Cap\hat{ }{d}_{j} represents a capacity upper limit of a certain warehouse j.

In addition, in terms of load balance, the logistics network optimization unit 130 adds expression (6) as a constraint that reduces load of the warehouse with maximum load using a decision variable L.

$$\begin{matrix}[ Math . 6 ] & \\ \begin{matrix}{\sum }_{i ∈ D} & {\sum }_{k ∈ K} & {\sum }_{p ∈ {P}^{k}} & {w}_{k} {δ}_{i , j}^{p} {z}_{p}^{k} \leq L , j ∈ D\end{matrix} & ( 6 )\end{matrix}$$

Note that left sides of expression (5) and expression (6) are the same, and only right sides are different. In a certain warehouse j, which of L or Cap_{d}_{j} is smaller is unclear until L is determined in the optimization processing, and thus, both constraint expressions are required.

Finally, the logistics network optimization unit 130 sets an objective function in the processing 1406. First, as the objective function, in terms of load balance, the logistics network optimization unit 130 adds L that becomes a right side of the constraint that reduces load of each warehouse. Further, the logistics network optimization unit 130 adds a total value of the expenses when the package passes through the respective edges, because it is required to carry the package at a minimum expense while load is balanced. In this event, when the edge included in the selected path candidate enters the warehouse that serves as a role different from the existing warehouse role, the cost becomes high because existing operation is changed, and when the edge enters the warehouse that serves as the same role as the existing role, the logistics network optimization unit 130 multiplies the objective function by a coefficient γ to achieve a lower cost. A mathematical expression that minimizes the above two items is as indicted in expression (7).

$$\begin{matrix}[ Math . 7 ] & \\ minimize {f}_{1} \begin{matrix}{\sum }_{( i , j ) ∈ E} & {\sum }_{k ∈ K} & {w}_{k} {c}_{i , j} {\sum }_{p ∈ {P}^{k}} & {δ}_{i , j}^{p} {γ}_{i , j}^{p} {z}_{p}^{k} + {f}_{2} L\end{matrix} & ( 7 )\end{matrix}$$

Here, c_{i, j} is an expense required for moving on the edge (i, j). Further, f_1 and f_2 are weight parameters that determine degrees of importance of respective terms and may be received as an input from the screen by the user or may be specified from the storage area of the logistics network planning system 100 in advance.

The logistics network optimization unit 130 solves the constructed optimization problem in processing 1407. As a solution method in this event, an arbitrary solution method for existing integer programming such as branch and bound may be used. It is also possible to use a commercially available solver for integer programming.

The processing 1206 ends using a decision variable z\hat{ }{k}_{p} obtained as a result as a return value.

Description will be returned to FIG. 12. The logistics network optimization unit 130 outputs the route of the package, that is, the logistics network plan data representing the created logistics network plan in the processing 1207 using the decision variable obtained in the optimization processing. The logistics network plan data may include, for example, a table including the package number of each package as a key and a list of warehouses to which the package is sorted (that is, warehouses at which transfer of the vehicle will occur) as a value. Note that if the route of the package from the departure store to the arrival store is determined once, which vehicle is used to transport each package under the known vehicle diagram can be determined using the existing scheme of solving a delivery planning problem. The logistics network optimization unit 130 stores a final result solved in this manner in a format that is the same as the format of the second package table 202 in FIG. 2 and ends the processing. Data including the data in the same format may be the logistics network plan data.

An example of the logistics network screen 1500 representing the planned logistics network will be described using FIG. 15.

The input/output unit 140 displays the logistics network screen on the user terminal 30. The logistics network screen 1500 includes, for example, a first screen element 1501 that displays the package route output in the processing 1207, a second screen element 1502 that displays information obtained through the processing 602 and the processing 603, and a third screen element 1503 that displays information on the package that moves on edges constituting the logistics network.

For example, the input/output unit 140 displays the warehouses that construct the logistics network and the logistics network by drawing a line between warehouses when there is a package that moves between the warehouses in the first screen element 1501. A display position of the warehouse in this event is determined based on coordinate information such as the latitude 412 and the longitude 413 of the warehouse data 103. A mark of the warehouse (vertex) may be a mark (for example, a rectangle in a case where the role is the inside-outside GW) in a display aspect in accordance with the warehouse role calculated through the processing 603. The display aspect of the mark may be a shape, color, or the like.

The second screen element 1502 displays information on classification and the role for each warehouse calculated through the processing 602 and the processing 603. This visualizes an analysis result of the feature of each warehouse in the existing logistics network.

The third screen element 1503 displays the package that moves on each edge and a role of the warehouse on the arrival store side in this event based on the package route obtained through the processing 1206 (optimization processing). Data to be used in creation of the plan may be selected from the logistics network screen 1500 and the processing of the logistics network planning system 100 may be executed again through manual operation by the user. By this means, planning is performed again by the logistics network planning system 100, and the logistics network, the analysis result of the warehouses, and the like, based on the calculation result are displayed on the screen again.

Further, by the user inputting the package data of the day, representing the package necessary to be transported on the day to the screen 1500 illustrated in FIG. 15, a transportation planning unit (not illustrated) may derive the package route of the package on the day and create a transportation plan based on data of the created logistics network plan and the input package data of the day. The transportation plan may be created based on vehicle data of the day (data having information on each of a plurality of vehicles that are available on the day) in addition to the package data of the day. By giving a transportation instruction to each vehicle and the warehouse within the logistics network based on the present plan, the transportation plan can be utilized in daily operation. Note that the “transportation planning unit” may be implemented by the processor 53 or may be implemented by the transportation planning system 40. A configuration of the package data of the day may be the same as the configuration of the first package table 201 for the package that is required to be transported on the day (for example, the occurrence time 215 is the day).

### Second Embodiment

In the first embodiment, a scheme for load balance has been described in terms of load balance among the warehouses in the logistics network. In the present embodiment, a scheme of concentrating the load on a specific warehouse inversely with the first embodiment will be described. Note that the second embodiment will be described mainly concerning points different from the first embodiment, and description of points common to the first embodiment will be omitted or simplified.

With the present scheme, as a result of increase in packages that pass through the specific warehouse, it is anticipated to improve loading ratios of vehicles that pass through the warehouse, and it can be expected to improve efficiency. In addition, vehicles that load few packages appear, and thus, by abolishing the vehicle diagram of the vehicles, reduction in a maintenance cost of the vehicles can be expected as an effect.

Such a scheme will be described. However, components in the second embodiment are the same as those in FIG. 1, and the logistics network planning system 100 executes processing similar to the processing from FIG. 1 to FIG. 15.

Differences from the first embodiment are setting of the constraint of the vertex in the processing 1405 in FIG. 14 and setting of the objective function in the processing 1406, to be executed by the logistics network optimization unit 130. Other description will be omitted.

It is assumed that the processing to the processing 1404 has been executed. The logistics network optimization unit 130 sets the constraint relating to the vertex in the processing 1405. Specifically, this constraint is a constraint as to whether or not an amount of packages to be flown into the warehouse exceeds the upper limit value for the capacity upper limit 512 of each warehouse. This can be implemented by setting a constraint such that a value obtained by adding weights of flowing packages when the edge that flows into the warehouse is selected as the path of the package route is equal to or less than the capacity upper limit. Specifically, the logistics network optimization unit 130 adds the constraint indicated in expression (8).

$$\begin{matrix}[ Math . 8 ] & \\ \begin{matrix}{\sum }_{i ∈ D} & {\sum }_{k ∈ K} & {\sum }_{p ∈ {P}^{k}} & {w}_{k} {δ}_{i , j}^{p} {z}_{p}^{k} \leq {Cap}_{j}^{d} , j ∈ D\end{matrix} & ( 8 )\end{matrix}$$

Note that a difference from the first embodiment is that the constraint expression (expression (6) in the first embodiment) that reduces the right side with L is not added, and expression (5) is the same as expression (8).

Further, the logistics network optimization unit 130 sets the objective function in the processing 1406.

First, the logistics network optimization unit 130 adds an expression that maximizes a difference in the workload between two warehouses in each area as the objective function in terms of load concentration. This expression is an expression for maximizing a difference between an amount of packages flowing into a warehouse j and an amount of packages flowing into a warehouse j′. While the optimization problem as a whole is directed to minimization, the logistics network optimization unit 130 adds the expression representing the difference in the amount of packages to the objective function as a negative value to express the above. Note that to omit warehouses for which load cannot be concentrated, such as a warehouse at the terminal, the targets in this event are limited to warehouses that serve as GWs. Such warehouses can be obtained by determining whether a ratio of a role as the GW recorded in the warehouse table 401 exceeds a predetermined value (designated by the user or recorded in advance as a file in the storage area of the logistics network planning system 100).

Further, it is desired to carry the package at the minimum expense, and thus, the logistics network optimization unit 130 adds a total value of expenses when the package passes through the respective edges. A mathematical expression that minimizes the above two items is as indicated in expression (9).

$$\begin{matrix}[ Math . 9 ] & \\ minimize \begin{matrix}{\sum }_{( i , j ) ∈ E} & {\sum }_{k ∈ K} & {w}_{k} {c}_{i , j} {\sum }_{p ∈ {P}^{k}} & {δ}_{i , j}^{p} {γ}_{i , j}^{p} {z}_{p}^{k} -\end{matrix} \begin{matrix}{\sum }_{i ∈ D} & \vert {\sum }_{k ∈ K} & {\sum }_{p ∈ {P}^{k}} & {\sum }_{j ∈ {D}^{′}} & {w}_{k} {δ}_{i , j}^{p} {z}_{p}^{k}\end{matrix} - \begin{matrix}{\sum }_{k ∈ K} & {\sum }_{p ∈ {P}^{k}} & {\sum }_{j ′ ∈ {D}^{″}} & {w}_{k} {δ}_{i , j}^{p} , {z}_{p}^{k}\end{matrix} \vert & ( 9 )\end{matrix}$$

Here, D′ is an aggregate of warehouses on which load is to be concentrated, and D″ is an aggregate of warehouses from which load is reduced inversely. An optimization range may be further limited by limiting an area, and the like, as well as simply by the ratio of the role of the GW.

The subsequent processing is similar to that in the first embodiment and thus will be omitted.

While some embodiments of the present invention have been described above, these embodiments are merely presented as examples and are not intended to limit the scope of the invention. The present invention can be implemented in other various forms, various omission, replacement and changes can be made within a range not deviating from the gist of the invention. These embodiments are included in the scope and the gist of the invention and are included in the invention recited in claims and an equivalent range thereof. For example, while the “weight” of the package is synonymous with the “capacity” in the above-described embodiments, the “capacity” of the package may be determined based on a volume, and the like, in place of or in addition to the weight in a broad sense.

Note that the above description can be summarized as follows. The following summary may include supplemental description of the above description and description of modifications of the above-described embodiments.

The logistics network planning system (for example, the logistics network planning system 100) includes an input unit (for example, the input/output unit 140), a logistics network analysis unit (for example, the logistics network analysis unit 120), a logistics network optimization unit (for example, the logistics network optimization unit 130), and an output unit (for example, the input/output unit 140). The input unit receives as an input the existing logistics network data that is data relating to the existing logistics network. The “existing logistics network” includes a plurality of package routes of a plurality of packages, and for each package, the package route is a route including two or more warehouses from the departure store of the package (the first departure warehouse) to the arrival store (the last arrival warehouse) as components, that is, a sequence of a series of warehouses from the departure store to the arrival store. The existing logistics network data may be one example of past record data. The existing logistics network data includes, for example, the package data 101, the vehicle data 102 and the warehouse data 103. The existing logistics network data may be received as an input from outside of the logistics network planning system or may be read from the storage apparatus. The logistics network analysis unit analyzes the existing logistics network data to specify the logistics network feature (feature of the existing logistics network). The logistics network optimization unit constructs an optimization problem that minimizes the target based on one or a plurality of indexes, based on the logistics network feature and derives an optimum package route by solving the optimization problem. The output unit outputs logistics network plan data that is data representing the planned logistics network including the derived package route. By this means, it is possible to create an optimum plan of the logistics network with less change of substances such as warehouses and transporters (transportation means). As the index, an arbitrary index such as a transportation cost, an amount of packages to a warehouse with the highest workload, and a workload difference set as a negative value between the warehouse with the highest workload and a warehouse with the lowest workload, can be employed. For example, the target may be the transportation cost, a weighted sum of the transportation cost and the amount of packages to the warehouse with the highest workload, or a weighted sum of the transportation cost and the workload difference set as the negative value between the warehouse with the highest workload and the warehouse with the lowest workload.

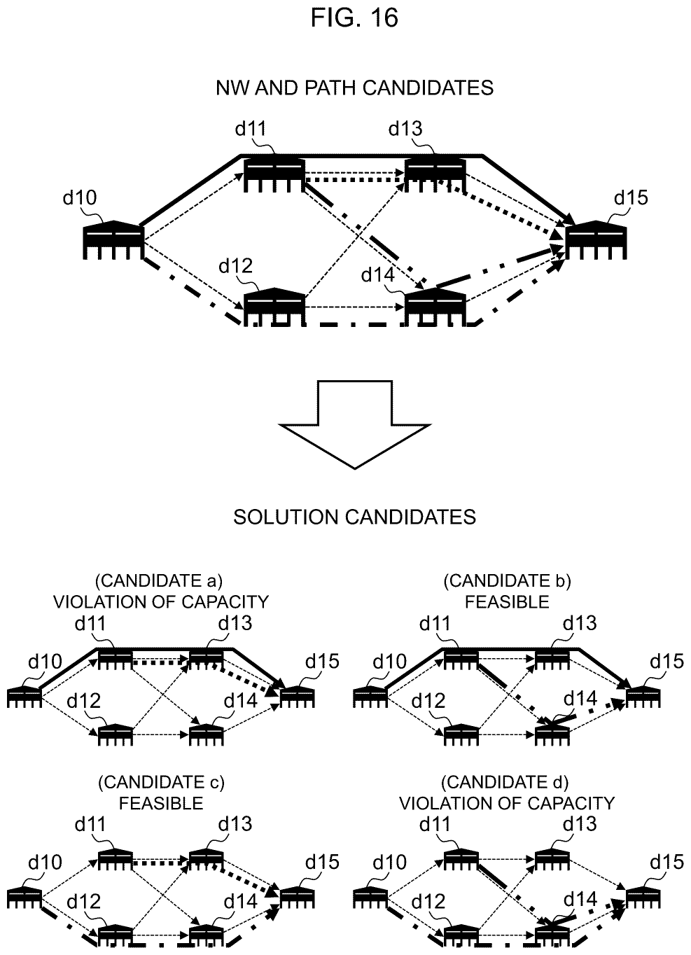

The existing logistics network data includes data representing a capacity of the package and a transporter on the package route of the package on an inter-warehouse basis for each of a plurality of packages and may include data representing a maximum loading capacity for each transporter. The logistics network optimization unit may determine the capacity upper limit between the warehouses based on a sum of the maximum loading capacities of the transporters that have passed through between the warehouses on an inter-warehouse basis based on the existing logistics network data. The logistics network optimization unit may construct the optimization problem so that one or more packages, a total capacity of which exceeds the capacity upper limit between the warehouses, do not pass through between the warehouses. By this means, it is possible to create an optimum plan of the logistics network with less change of substances. One example will be described with reference to FIG. 16.

To construct the optimization problem, the logistics network optimization unit 130 may generate path candidates and may derive the package route by selecting the package route from the path candidates. The following (1) to (6) may be provided as premises. According to the following premises, as illustrated in FIG. 16, candidates that are feasible in parallel (a case where a package 1 and a package 2 can be transported in parallel) are a candidate b and a candidate c. Further, in the following description, an element expressed by “dxx” (“xx” is a numerical value) is a warehouse.

1) The inputs are the following (1a) to (1c).
(1a) Data representing a graph having warehouses relating to the existing logistics network as vertexes and having a directed edge between warehouses to which transportation has been performed (for example, at least part of the graph data 104).
(1b) Data having the weight, the departure store and the arrival store for each package (for example, at least part of the package data 101)
(1c) Data of a plurality of path candidates for a plurality of packages (data of each of one or more path candidates for the package may be a sequence of a series of warehouses from the departure store to the arrival store of the package for each package)
(2) The constraint is an upper limit of the sum of capacities of the packages that can flow on the edge (a sum of loading amounts of one or more vehicles that move between the warehouses), and, for example, a value represented by the capacity 524 for each edge. In this example, the upper limit of the sum of the capacities of each edge is “70”.
(3) The purpose is minimization of the transportation cost. The transportation cost may be a cost in accordance with at least one index among a movement expense between the warehouses (for example, a fuel expense), a moving distance, a moving period and environmental load (for example, a CO₂ emission amount).
(4) The decision variable is whether or not the path candidate is selected (for example, a binary of “0” or “1”).
(5) There are two package 1 and package 2, which are as described below. Note that the number of the path candidates that can be taken in a range of an upper limit may be generated for each package. In this example, the upper limit of the number of path candidates may be two for each package. Further, the “capacity” of the package may be determined based on a volume, and the like, in place of or in addition to the weight.
(5a) The capacity of the package 1 is “50”. The path candidates for the package 1 are d10→d11→d13→d15 (thick solid line) and d10→d12→d14→d15 (thick dash-dotted line).
(5b) The capacity of the package 2 is “50”. The path candidates for the package 2 are d11→d13→d15 (thick solid line) and d11→d14→d15 (thick dash-dot-dot line).
(6) The cost function is “1” for all the edges.

The existing logistics network data includes data representing departure time and departure and arrival time for each of the warehouses constituting the package route of the package and a transporter on the package route on an inter-warehouse basis for each of a plurality of packages and may include data representing an area for each warehouse. The logistics network analysis unit may include, for example, the warehouse role estimation unit 121. Concerning each warehouse at which the package has been unloaded and loaded, for each package, in a case where a transporter that has transported the package to the warehouse is different from a transporter that has transported the package from the warehouse to a warehouse of the next movement destination (that is, in a case where the package has been transferred from the transporter to another transporter), the logistics network analysis unit may provide to the warehouse, a warehouse role in accordance with whether transportation of the package to the warehouse is branch line transportation or trunk line transportation and whether transportation of the package from the warehouse to the warehouse of the next movement destination is branch line transportation or trunk line transportation. The branch line transportation is transportation between warehouses located in the same area. The trunk line transportation is transportation between warehouses located in different areas. The logistics network feature may include a warehouse role feature relating to one or more warehouse roles during a fixed period of the warehouse for each warehouse. The logistics network optimization unit may construct the optimization problem so that the transportation cost becomes lower as divergence from the warehouse role is smaller.

While there is convention of operation (for example, a warehouse mainly performs branch line transportation cannot receive packages of the trunk line) in the existing logistics network that has been constructed from the past, it is possible to create an optimum plan of the logistics network while following such convention (that is, with less change of substances that are warehouses). Further, while there is a possibility that there is divergence between initial design of the warehouse and a current status after long periods of time, even if such divergence occurs, the current warehouse role is estimated, and the optimum package route is derived based on the estimated warehouse role, so that it is possible to create an appropriate logistics network plan.

The “warehouse role feature” may be based on a ratio or a frequency of each of one or more warehouse roles during a fixed period of the warehouse for each warehouse. For example, the warehouse role feature may include a ratio or a frequency of the estimated warehouse role for each warehouse or may include the warehouse role finally estimated from the ratio or the frequency of the estimated warehouse role (for example, the warehouse role with the highest ratio or frequency). The logistics network optimization unit may construct the optimization problem so that a degree of increase of the transportation cost that increases as the divergence from the warehouse roles is greater increases as the ratio of the warehouse role becomes higher. By this means, a more appropriate logistics network plan can be expected.

As one example, for each warehouse role, a correction constant becomes greater as a value obtained by subtracting the ratio or the frequency of the warehouse role (for example, the coefficients 514 to 517 described above) from a predetermined value (for example, “1”) is greater, and if the warehouse role of the warehouse in the package route matches the warehouse role with the great correction constant, divergence from the warehouse role is great, and thus, the transportation cost becomes high. By this means, it can be expected to avoid creation of a logistics network plan with great divergence from the warehouse role.

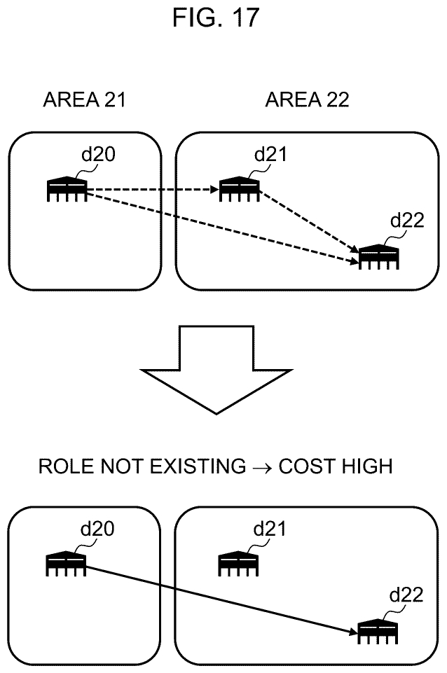

Specifically, it is, for example, assumed in FIG. 17 that d21 has a role as the outside-inside GW, and d22 does not have a role as the GW. There are d20→d21→d22 and d20→d22 as the package route from d20 to d22. In a case where only a cost such as a moving distance and a fuel expense is taken into account, d20→d22 is more likely to be selected than d20→d21→d22. However, if d20→d22 is selected, d22 requires a system for trunk line transportation. In other words, it is necessary to change d22. Thus, the optimization problem that increases a cost in a case where a package route that requires change in the role of d22 is selected, may be constructed. Note that in construction of the optimization problem, it is more preferable that load balance in accordance with similarity of the warehouses is implemented as will be described later in addition to the correction constant in accordance with a degree of divergence from the warehouse role.

The existing logistics network data may include time-series data of the workload for each warehouse in the existing logistics network. The workload of the warehouse may be based on an unloading amount and a loading amount for each warehouse. The logistics network optimization unit may construct the optimization problem so as to minimize an amount of packages to the warehouse with the highest workload. By this means, it can be expected to avoid creation of a logistics network plan in which workload (load) concentrates on a certain warehouse.

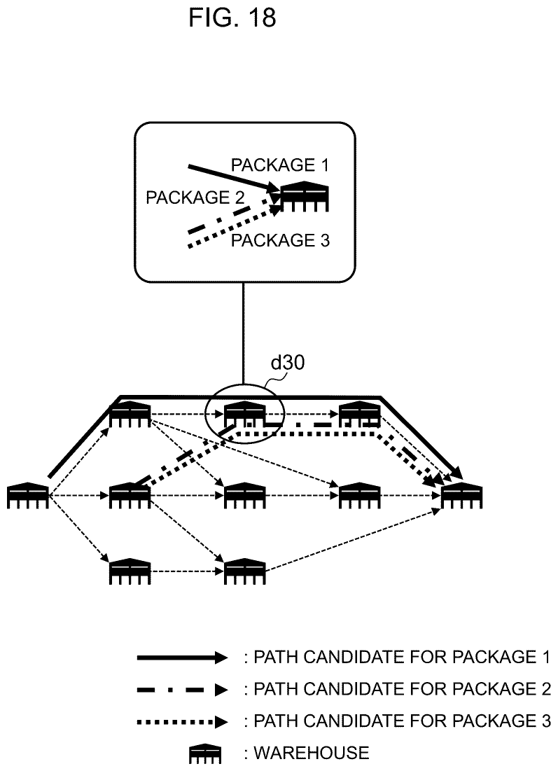

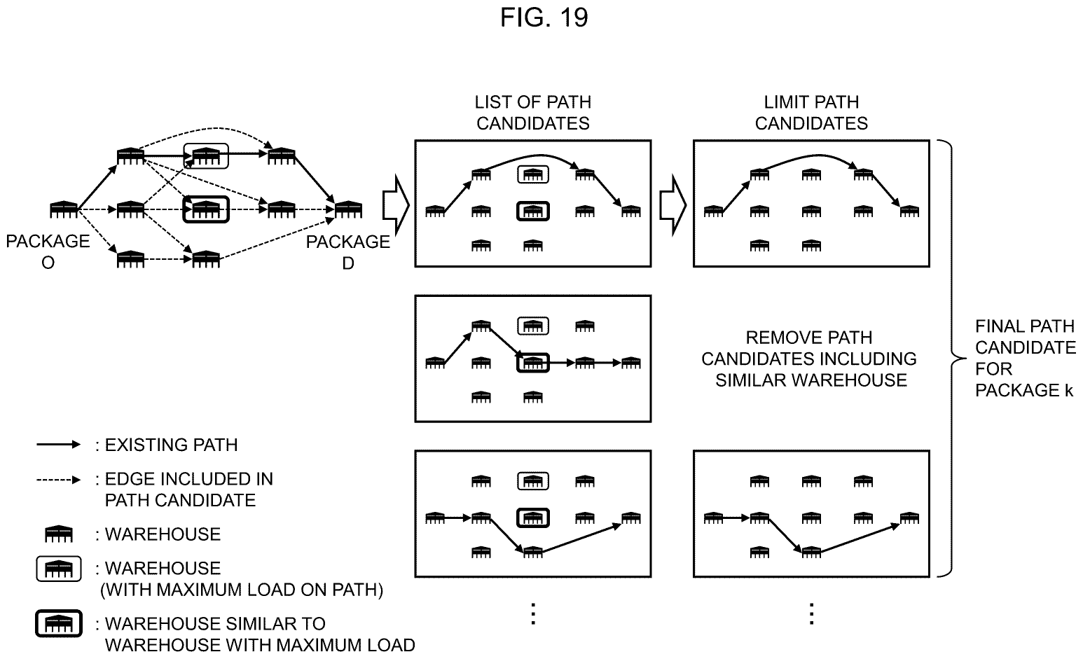

Specifically, for example, in a case where path candidates for the packages 1 to 3 are as illustrated in FIG. 18, if only the cost is taken into account, load (a sum of capacities of packages to flow into the warehouse) concentrates on d30 with a low cost. To avoid such load concentration, modeling is performed so as to reduce an amount of load on the warehouse on which the highest load is placed. For example, the decision variable L indicating the maximum inflow package amount may be prepared as the objective function. A constraint that reduces a total capacity that can be accommodated in each warehouse with L may be added (a maximum value is minimized). As the constraint, an optimization problem is constructed such that a sum of capacities of packages to be transported from the warehouse i to the warehouse j is equal to or less than the capacity upper limit corresponding to the edge (i, j) and a maximum value of the sum of the capacities of the packages to the warehouse j is minimized.

The existing logistics network data may include time-series data of workload for each warehouse in the existing logistics network. For each warehouse, the workload of the warehouse may be based on the unloading amount and the loading amount. The logistics network feature may include similarity feature relating to time-series similarity of the workload between warehouses. The logistics network optimization unit may construct the optimization problem so as to avoid two or more warehouses that are similar to each other from being included in the same package route. By this means, it can be expected to create a logistics network plan in which load of warehouses is balanced (for example, as described with reference to FIG. 9A and FIG. 9B).

Specifically, for example, it is assumed in generation of path candidates that the cost is lower as the number of warehouses through which the package passes is less. The number of path candidates is exponential, and thus, it is difficult to generate all path candidates. Thus, the logistics network optimization unit 130 may first list path candidates having the number of warehouses through which the package passes equal to or less than the upper limit for each package. This “upper limit” may be input by the user or may be determined in advance. Depth-first search may be applied to listing of the path candidates. The logistics network optimization unit 130 may calculate the cost for each path candidate in consideration of the warehouse role. For example, the cost may be a sum of costs corresponding to the edges (i, j) constituting the path candidate. The logistics network optimization unit 130 may set an existing path from the existing logistics network. The logistics network optimization unit 130 may specify a warehouse (for example, a warehouse having similar time-series workload) similar to a warehouse with high load (for example, a warehouse with load equal to or higher than a threshold or a warehouse with the highest load) from the existing logistics network and may set path candidates that do not pass through the similar warehouse, and the existing path as the path candidates. In other words, path candidates other than the existing path may be path candidates that do not pass through the warehouse similar to the warehouse with high load.

The existing logistics network data may include time-series data of the workload for each warehouse in the existing logistics network. The logistics network optimization unit may construct the optimization problem so as to maximize the workload difference between the warehouse with the highest workload and the warehouse with the lowest workload. By this means, packages that pass through a specific warehouse increase, and thereby it is anticipated to improve a loading ratio of the transporter that passes through the warehouse, and it can be expected to improve efficiency.

The output unit may provide a user interface (UI) screen in accordance with the logistics network plan data. One example of the UI screen is the logistics network screen 1500 illustrated in FIG. 15. The UI screen may have a graph having warehouses as vertexes and a directed edge between warehouses on the package route relating to the logistics network including the derived plurality of optimum package routes, and information on a plurality of warehouses corresponding to a plurality of vertexes constituting the graph. By this means, the user (for example, a planner) can easily grasp the created logistics network plan, and thus can easily create a transportation plan. For example, the information on the plurality of warehouses in the graph may include information on the warehouses on the package route selected by the user from the graph, may include information representing a warehouse role of the warehouse (for example, a warehouse role with the highest ratio or frequency) or may include information representing the role ratio of the warehouse. A display aspect of the vertex in the graph may be a display aspect (for example, a shape, color or a size) in accordance with the warehouse role feature (for example, the warehouse role with the highest ratio or frequency) corresponding to the vertex.

The output unit may output the logistics network plan data as logistics network data to a transportation planning unit (for example, the transportation planning system 40) that generates transportation plans of a plurality of packages to be transported based on the logistics network data in which a plurality of package routes are defined and target package data relating to the plurality of packages. The transportation planning unit may generate the transportation plans of the plurality of packages to be transported based on the target package data and the logistics network plan data. By this means, it can be expected to contribute to generation (creation) of appropriate transportation plans.

1. A logistics network planning system comprising:
an input unit that receives, as an input, existing logistics network data that is data relating to an existing logistics network constituted with a plurality of package routes including two or more warehouses from a first departure warehouse to a last arrival warehouse of a package as components;
a logistics network analysis unit that analyzes the existing logistics network data to specify a logistics network feature that is a feature of the existing logistics network;
a logistics network optimization unit that constructs an optimization problem that minimizes a target based on one or a plurality of indexes, based on the logistics network feature and derives an optimum package route by solving the optimization problem; and
an output unit that outputs logistics network plan data that is data representing a planned logistics network including the derived package route.

2. The logistics network planning system according to claim 1, wherein
the existing logistics network data includes data representing departure time and departure and arrival time for each of the warehouses constituting the package route of the package and a transporter on the package route on an inter-warehouse basis for each of the plurality of packages and includes data representing an area for each warehouse,
for each warehouse at which the package is unloaded and loaded, in a case where a transporter that has transported the package to the warehouse is different from a transporter that has transported the package from the warehouse to a warehouse of the next movement destination for each package, the logistics network analysis unit provides to the warehouse, a warehouse role in accordance with whether the transportation of the package to the warehouse is branch line transportation or trunk line transportation, and whether the transportation of the package from the warehouse to the warehouse of the next movement destination is branch line transportation or trunk line transportation,
the branch line transportation is transportation between warehouses located in the same area,
the trunk line transportation is transportation between warehouses located in different areas,
the logistics network feature includes a warehouse role feature relating to one or more warehouse roles of the warehouse during a fixed period for each of the warehouses, and
the logistics network optimization unit constructs the optimization problem so that a transportation cost becomes lower as divergence from the warehouse role is smaller.

3. The logistics network planning system according to claim 2, wherein
the warehouse role feature may be based on a ratio or a frequency of each of the one or more warehouse roles of the warehouse during the fixed period for each of the warehouses, and
the logistics network optimization unit constructs the optimization problem so that a degree of increase of the transportation cost that increases as the divergence from the warehouse roles is greater increases as the ratio of the warehouse role becomes higher.

4. The logistics network planning system according to claim 1, wherein
the existing logistics network data includes time-series data of workload for each of the warehouses in the existing logistics network,
for each of the warehouses, the workload of the warehouse is based on an unloading amount and a loading amount,
the logistics network feature includes a similarity feature relating to time-series similarity of the workload between warehouses, and
the logistics network optimization unit constructs the optimization problem so as to avoid two or more warehouses that are similar to each other from being included in the same package route.

5. The logistics network planning system according to claim 1, wherein
the existing logistics network data includes time-series data of workload for each of the warehouses in the existing logistics network,
for each of the warehouses, the workload of the warehouse is based on an unloading amount and a loading amount, and
the logistics network optimization unit constructs the optimization problem so as to minimize an amount of packages to a warehouse with the highest workload.

6. The logistics network planning system according to claim 1, wherein
the existing logistics network data includes time-series data of workload for each of the warehouses in the existing logistics network,
for each of the warehouses, the workload of the warehouse is based on an unloading amount and a loading amount, and
the logistics network optimization unit constructs the optimization problem that maximizes a workload difference between a warehouse with the highest workload and a warehouse with the lowest workload.

7. The logistics network planning system according to claim 1, wherein
the output unit provides a user interface (UI) screen in accordance with the logistics network plan data, and
the UI screen includes:
a graph having warehouses as vertexes and a directed edge between warehouses in the package route relating to a logistics network constituted with a plurality of derived optimum package routes; and
information on a plurality of warehouses corresponding to a plurality of vertexes constituting the graph.

8. The logistics network planning system according to claim 1, wherein
the output unit outputs the logistics network plan data as logistics network data in which a plurality of package routes are defined to a transportation planning unit that generates transportation plans of a plurality of packages to be transported based on the logistics network data and target package data relating to the plurality of packages, and
the transportation planning unit generates transportation plans of the plurality of packages to be transported based on the target package data and the logistics network plan data.

9. The logistics network planning system according to claim 1, wherein
the existing logistics network data includes, for each of the plurality of packages, data representing a capacity of the package and a transporter on a package route of the package on an inter-warehouse basis, and includes data representing a maximum loading capacity for each transporter,
on an inter-warehouse basis, the logistics network optimization unit determines a capacity upper limit between the warehouses based on a sum of maximum loading capacities of transporters that pass through between the warehouses, based on the existing logistics network data, and
the logistics network optimization unit constructs the optimization problem such that one or more packages for which a total of capacities exceeds the capacity upper limit between the warehouses do not pass through between the warehouses.

10. The logistics network planning system according to claim 1, wherein the target is a transportation cost.

11. The logistics network planning system according to claim 1, wherein the target is a weighted sum of a transportation cost and an amount of packages to a warehouse with the highest workload.

12. The logistics network planning system according to claim 1, wherein the target is a weighted sum of a transportation cost and a workload difference set as a negative value between a warehouse with the highest workload and a warehouse with the lowest workload.

13. A logistics network planning method executed by a computer comprising:
inputting existing logistics network data that is data relating to an existing logistics network constituted with a plurality of package routes including two or more warehouses from a first departure warehouse to a last arrival warehouse of a package as components;
analyzing the existing logistics network data to specify a logistics network feature that is a feature of the existing logistics network;
constructing an optimization problem that minimizes a target based on one or a plurality of indexes, based on the logistics network feature and derives an optimum package route by solving the optimization problem; and
outputting logistics network plan data that is data representing a planned logistics network including the derived package route.
